(19) United States
(12) Patent Application Publication
(10) Pub. No.: US 2016/0322031 A1
(43) Pub. Date: Nov. 3, 2016

(54) Cost-Effective In-Bin Primitive Pre-Ordering In GPU

(71) Applicant: MediaTek Singapore Pte. Ltd., Singapore (SG)

(72) Inventors: Qun-Feng Liao, San Jose, CA (US); Xiayang Zhao, San Jose, CA (US)

(21) Appl. No.: 14/697,744

(22) Filed: Apr. 28, 2015

(51) Int. Cl. G09G 5/39

(52) U.S. Cl. CPC G09G 5/39

(57) ABSTRACT

Embodiments of techniques of cost-effective in-bin primitive pre-ordering in a graphics processing unit (GPU) are described. In one example implementation, a control circuit of the GPU may receive data related to a plurality of primitives. The control circuit may store identifications of a set of visible primitives among the plurality of primitives in a first buffer of the GPU for a plurality of pixels of the bin. Each visible primitive may correspond to a respective pixel of the bin. At each pixel of the bin, a depth of the visible primitive relative to an image plane may be less than a depth of each of one or more other primitives of the plurality of primitives relative to the image plane. The control circuit may provide the identifications of the visible primitives to a rendering unit in batches for rendering of the pixels of the bin.

### TECHNICAL FIELD

The present disclosure is generally related to graphics processing and, more particularly, to pre-ordering of primitives in a graphics processing unit (GPU).

### BACKGROUND

Unless otherwise indicated herein, approaches described in this section are not prior art to the claims listed below and are not admitted to be prior art by inclusion in this section.

In tile-based deter-rendering, or binning, graphics processing systems, the order of rendering inside a bin typically follows the order of incoming primitives with hidden surface removal (HSR) performed first as an option. While rendering primitives in the incoming order of the primitives is a rather simple way, it is possible that one or more later-rendered primitives may obscure previously-rendered primitives. In such scenario, a GPU would unnecessarily render pixel(s) of primitive(s) in a bin obscured by the later-rendered primitives.

An alternative approach is to perform a pre-Z test before binning to build a coarse Z, or depth, range for occlusion of some primitives. However, HSR cannot be performed completely due to the coarse-grained nature of the coarse Z range.

In order to remove obscured primitives completely, a pass is necessary to walk through all primitives in a bin to update the depth on the fly. This allows just the visible pixels to be presented to the following shader stages, e.g., fragment shader. One approach is to identify the visible pixels with an early fine-Z test, but a few problems either remain unsolved or have no cost-effective solution. In particular, there is a need for a solution to mark visible pixels and their associated primitives in a cost-effective way. There is also a need for a solution to handle transparent pixels in a plural quantity in any given pixel location. There is also a need for a solution to handle order-dependent transparent (ODT) primitives. There is a further need for a cost-effective solution to handle order-independent transparent (OIT) primitives, if an application does not pre-order or otherwise pre-order, or sort, the primitives.

### SUMMARY

An objective of the present disclosure is to provide a solution to mark visible pixels and their associated primitives in a cost-effective way. Another objective of the present disclosure is to provide a solution to handle transparent pixels in a plural quantity in any given pixel location. A further objective of the present disclosure is to provide a cost-effective solution to handle ODT primitives. An additional objective of the present disclosure is to provide a cost-effective solution to handle OIT primitives, if an application does not pre-order the primitives.

In one example implementation, a device implementable in a GPU may include a first buffer and a control circuit coupled to the first buffer. For each pixel of a plurality of pixels of a bin, the control circuit may determine a primitive of a plurality of primitives associated with the bin as a respective visible primitive at the pixel. Each pixel of the bin may correspond to one or more primitives of the plurality of primitives. A depth of the respective visible primitive relative to an image plane at each pixel may be less or not greater than a depth of each of other primitives of the plurality of primitives relative to the image plane at the pixel. For each pixel of the plurality of pixels of the bin, the control circuit may also store an identification of the respective visible primitive in the first buffer such that identifications of a set of visible primitives for the plurality of pixels of the bin are stored in the first buffer. The control circuit may further dispatch or otherwise provide at least the identifications of the set of visible primitives for rendering of the plurality of pixels of the bin.

In another example implementation, a method implementable in a GPU may involve a control circuit processing data related to a plurality of primitives associated with a bin, with the plurality of primitives including one or more opaque primitives. The method may also involve the control circuit identifying one or more primitives of the plurality of primitives as a set of visible primitives for a plurality of pixels of the bin. Each visible primitive of the set of visible primitives may correspond to a respective pixel of the plurality of pixels of the bin. At each pixel of the bin, a depth of the visible primitive relative to an image plane may be less or not greater than a depth of each of one or more other primitives of the plurality of primitives relative to the image plane. The method may further involve the control circuit providing at least identifications of the set of visible primitives in batches for rendering of the plurality of pixels of the bin such that a batch of multiple pixels of the plurality of pixels of the bin are rendered at a time.

In yet another example implementation, a GPU may include a first buffer, a second buffer, a rendering unit, and a control circuit coupled to the first buffer, the second buffer and the rendering unit. The control circuit may store identifications of a set of visible primitives among one or more primitives of a plurality of primitives associated with the bin in the first buffer. Each visible primitive may correspond to a respective pixel of a plurality of pixels of the bin such that data related to the set of visible primitives is used in rendering the plurality of pixels of the bin. Each pixel of the bin may correspond to one or more primitives of the plurality of primitives. At each pixel of the bin, a depth of the corresponding visible primitive relative to an image plane may be less or not greater than a depth of each of one or more other primitives of the plurality of primitives relative to the image plane. The control circuit may also store values of the depths of the set of visible primitives corresponding to the plurality of pixels of the bin in the second buffer. Subsequent to storing the identifications of the set of visible primitives in the first buffer, the control circuit may dispatch or otherwise provide at least the identifications of the set of visible primitives in batches. The rendering unit may receive the identifications of the visible primitives from the first buffer. The rendering unit may also render the plurality of pixels of the bin in batches based at least in part on data related to the visible primitives such that a batch of multiple pixels of the plurality of pixels of the bin are rendered at a time.

Advantageously, the use of a buffer, which stores identifications of visible primitives for pixels of a bin, and a control circuit in various embodiments of the present disclosure enables pre-ordering of primitives for rendering of the pixels of the bin in a cost-effective way for each bin of a plurality of bins of a frame. This also provides the benefit of minimizing the amount of data sent to a rendering unit, e.g., a shader, to avoid unnecessary rendering of pixels using data associated with obscured/occluded primitives. Moreover, embodiments of the present disclosure are applicable to opaque primitives as well as both ODT primitives and OIT primitives.

The foregoing summary is illustrative only and is not intended to be limiting in any way. That is, the foregoing summary is provided to introduce concepts, highlights, benefits and advantages of the novel and non-obvious techniques described herein. Select embodiments are further described below in the detailed description. Thus, the foregoing summary is not intended to identify essential features of the claimed subject matter, nor is it intended for use in determining the scope of the claimed subject matter.

### BRIEF DESCRIPTION OF THE DRAWINGS

The accompanying drawings are included to provide a further understanding of the disclosure, and are incorporated in and constitute a part of the present disclosure. The drawings illustrate embodiments of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example framework implementing various embodiments in accordance with the present disclosure.

FIG. 2 is a diagram showing an example scenario having different opaque and transparent primitives at different depths from an image plane with respect to a pixel in accordance with an embodiment of the present disclosure.

FIG. 3 is a flowchart of an example algorithm in accordance with an embodiment of the present disclosure.

FIG. 4 is a flowchart of another example algorithm in accordance with an embodiment of the present disclosure.

FIG. 5 is a flowchart of yet another example algorithm in accordance with an embodiment of the present disclosure.

FIG. 6 is a flowchart of still another example algorithm in accordance with an embodiment of the present disclosure.

FIG. 7 is a block diagram of an example scheme configured to execute the example algorithms of the present disclosure.

FIG. 8 is a block diagram of an example apparatus in accordance with an embodiments of the present disclosure.

FIG. 9 is a flowchart of an example process of cost-effective in-bin primitive pre-ordering in accordance with an embodiment of the present disclosure.

FIG. 10 is a flowchart of another example process of cost-effective in-bin primitive pre-ordering in accordance with an embodiment of the present disclosure.

FIG. 11 is a flowchart of yet another example process of cost-effective in-bin primitive pre-ordering in accordance with an embodiment of the present disclosure.

### DETAILED DESCRIPTION OF PREFERRED EMBODIMENTS

### Overview

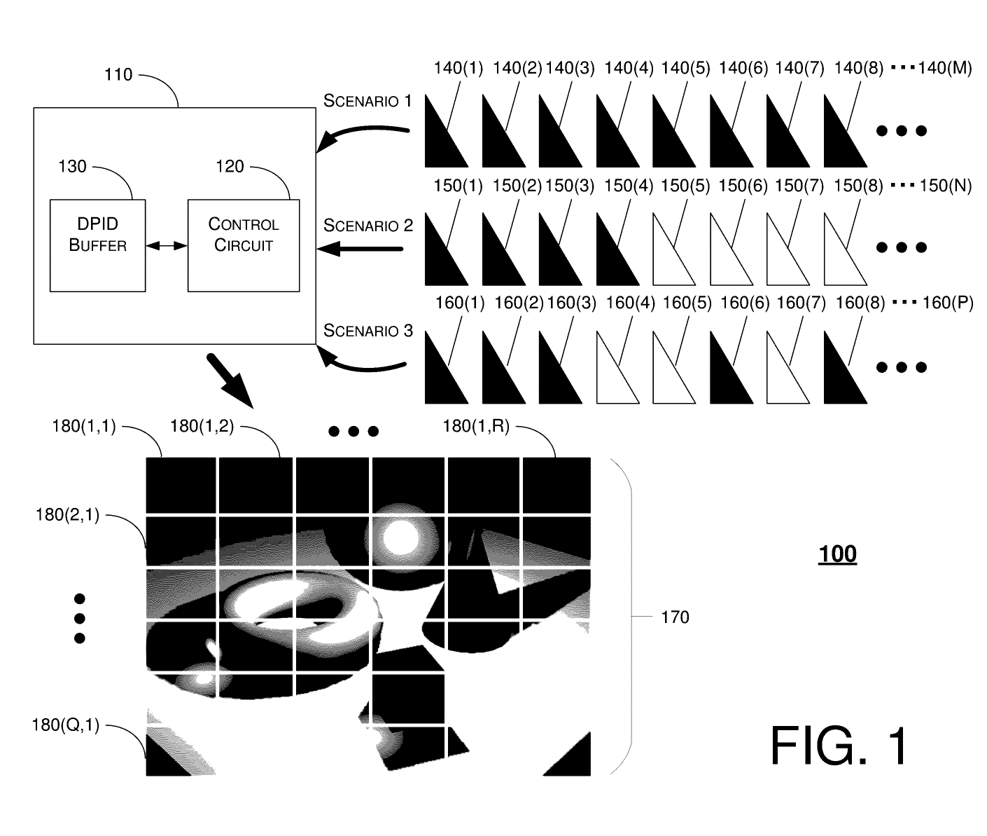

FIG. 1 is a diagram of an example framework 100 in which various embodiments in accordance with the present disclosure may be implemented. Example framework 100 may include an example device 110 which is configured to implement techniques, algorithms, processes, methods and various embodiments related to cost-effective in-bin primitive pre-ordering, or sorting, for pixels of a bin of a number of bins of a frame to be displayed in accordance with the present disclosure.

For instance, example device 110 may implement embodiments related to cost-effective in-bin primitive pre-ordering under different scenarios including, but not limited to, Scenario 1, Scenario 2 and Scenario 3. Regardless of the scenario, example device 110 may receive a number of primitives, e.g., sequentially, in their incoming order to perform pre-ordering of the primitives for pixels of the bin to identify one or more particular primitives as the visible primitive for each pixel of the pixels of the bin. In pre-ordering the primitives, for a given pixel of the pixels of a bin, example device 110 may determine a depth of each of the primitives at the given pixel relative to an image plane of the bin. For example, data associated with each primitive may indicate the depth of the primitive at every pixel of the bin that corresponds to the primitive. As each pixel of the bin corresponds to, or intersects with, one or more primitives, for each pixel of the bin example device 110 may perform a Z test on the one or more primitives corresponding to the pixel to determine which of the one or more corresponding primitives is nearest or otherwise closest to the image plane, i.e., the one with the smallest Z value, or value of depth, at that pixel. For each pixel of the bin, example device 110 may denote or otherwise identify the primitive that is closest to the image plane at the pixel as the visible primitive corresponding to that pixel. Example device 110 may also dispatch or otherwise provide identifications of the visible primitives corresponding to the pixels of the bin to a subsequent stage for rendering, e.g., shading and/or texturing. In some embodiments, example device 110 may dispatch or otherwise provide other information related to the visible primitives, e.g., one or more attributes of the visible primitives, when providing identifications of the visible primitives to the subsequent stage. In some embodiments, example device 110 may dispatch or otherwise provide at least the identifications of the visible primitives in batches, or waves, such that a batch or wave of multiple pixels of the pixels of the bin are rendered at a time. In some embodiments, example device 110 may include one or more subsequent stages of graphics processing and may performing rendering, e.g., shading and/or texturing, using data of the visible primitives for the pixels of a given bin.

In Scenario 1, example device 110 may perform cost-effective in-bin pre-ordering for a number of opaque primitives, in a sequential order. As shown in FIG. 1, in Scenario 1, example device 110 is configured to perform pre-ordering for primitives 140(1), 140(2), 140(3), 140(4), 140(5), 140(6), 140(7), 140(8), . . . , 140(M), all of which being opaque primitives. In Scenario 2, example device 110 may perform cost-effective in-bin pre-ordering first for a number of opaque primitives and then for a number of transparent primitives, in a sequential order. As shown in FIG. 1, in Scenario 2, example device 110 is configured to perform pre-ordering for primitives 150(1), 150(2), 150(3), 150(4), 150(5), 150(6), 150(7), 150(8), . . . , 150(N), with primitives 150(1)-150(4) being opaque primitives and primitives 150(5)-150(N) being transparent primitives. In Scenario 3, example device 110 may perform cost-effective in-bin preordering for a number of opaque primitives and then for a number of transparent primitives, in a sequential order, with one or more opaque primitives interleaved with the transparent primitives. As shown in FIG. 1, in Scenario 3, example device 110 is configured to perform pre-ordering for primitives 160(1), 160(2), 160(3), 160(4), 160(5), 160(6), 160(7), 160(8), . . . , 160(P), with primitives 160(1)-160(3), 160(6) and 160(8) (and maybe one or more primitives) being opaque primitives and primitives 160(4), 160(5) and 160(7) (and maybe one or more primitives) being transparent primitives.

In example framework 100, regardless of the scenario, the incoming primitives are pre-ordered and dispatched by example device 110 for rendering (which may optionally be performed by example device 110) for display at pixels of a given bin of a frame 170. Frame 170 may be displayed, e.g., on a screen, a monitor, a display panel, a touch-sensing panel, an input/output device, an output device or an interface device. As shown in FIG. 1, frame 170 may be divided into multiple bins, or regions, such as bins 180(1,1), 180(1,2) . . . , 180(1,R), 180(2,1), . . . , 180(Q,1). Each of the bins 180(1,1), 180(1,2) . . . , 180(Q,R) includes a respective number of pixels. For example, each bin may include 1024 pixels arranged in 32 rows and 32 columns.

In Scenario 1, one or more primitives of primitives 140(1)-140(M) may intersect with, or correspond to, each bin of bins 180(1,1)-180(Q,R). In Scenario 2, one or more primitives of primitives 150(1)-150(N) may intersect with, or correspond to, each bin of bins 180(1,1)-180(Q,R). In Scenario 3, one or more primitives of primitives 160(1)-160(P) may intersect with, or correspond to, each bin of bins 180(1,1)-180(Q,R). That is, regardless of the scenario, one or more of the incoming primitives may be processed to render one or more pixels of each bin of frame 170.

Example device 110 may include at least a control circuit 120 and a depth-primitive identification (DPID) buffer 130 which is coupled to control circuit 120. In some embodiments, example device 110 may be implementable in a GPU. In some other embodiments, example device 110 may be a GPU. Alternatively, example device 110 may be implementable in an image signal processor (ISP), a digital signal processor (DSP), a central processing unit (CPU) or any suitable processor. In some embodiments, DPID buffer 130 may have a size the same as that of each bin of a frame. That is, DPID buffer 130 may have the size sufficient to store relevant information of visible primitives for the pixels of a bin.

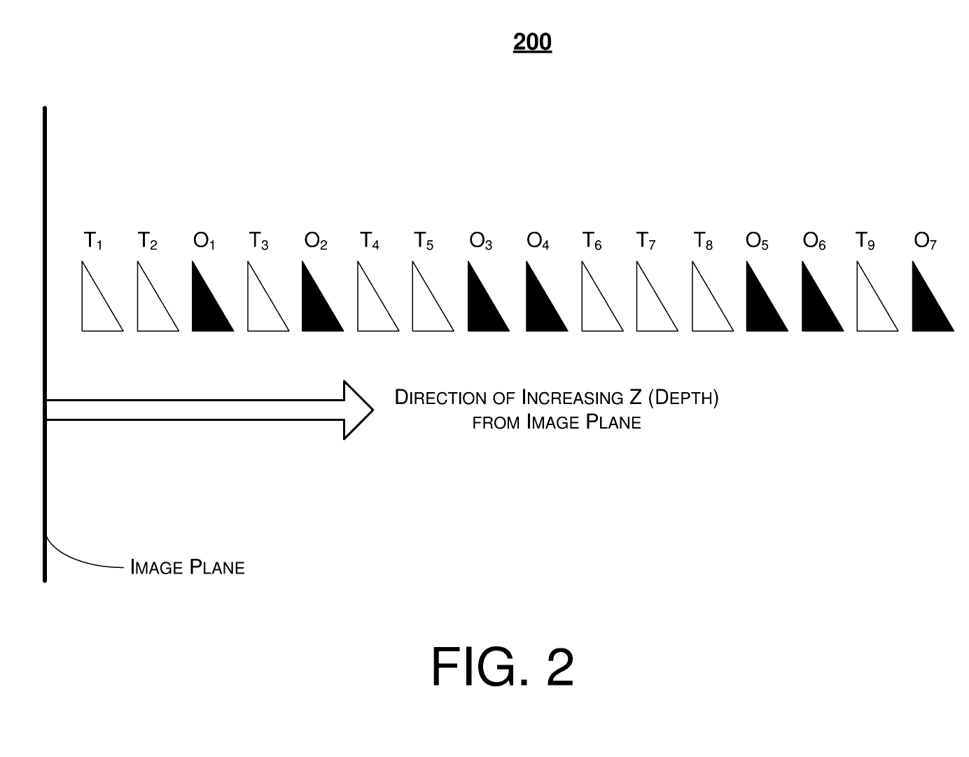

FIG. 2 is a diagram showing an example scenario 200 having different opaque and transparent primitives at different depths from an image plane with respect to a pixel in accordance with an embodiment of the present disclosure. In example scenario 200, the particular pixel corresponds to a number of primitives including opaque primitives O₁-O₇ and transparent primitives T₁-T₉. As shown in FIG. 2, among the different primitives, opaque primitive O₁ has the smallest Z value or value of depth among the opaque primitives O₁-O₇. However, transparent primitives T₁ and T₂ have even smaller Z values or values of depth than that of opaque primitive O₁, with transparent primitive T₁ having the smallest value of depth among all of the primitives O₁-O₇ and T₁-T₉. Thus, in example scenario 200 opaque primitive O₁ is the only visible opaque primitive at the particular pixel. All other opaque and transparent primitives having greater values of depth than that of opaque primitive O₁ are not visible at the particular pixel because they are obscured or otherwise occluded by opaque primitive O₁. Accordingly, embodiments of the present disclosure will not process opaque primitives O₂-O₇ and T₃-T₉ when rendering the particular pixel, thus minimizing the amount of data sent to a rendering unit, e.g., a shader, to avoid unnecessary rendering of the pixel using data associated with obscured/occluded primitives.

As for transparent primitives T₁ and T₂, which have smaller values of depth than that of opaque primitive O₁ and thus are visible, embodiments of the present disclosure may render them either in an order in which they are received/processed or in a descending order based on their respective values of depth. When transparent primitives T₁-T₉ are ODT primitives, meaning in rendering a given pixel with some or all of the transparent primitives T₁-T₉ the order in which some or all of the transparent primitives T₁-T₉ are processed is dependent on the order in which these transparent primitives are received for processing (i.e., the incoming order of the transparent primitives does matter), embodiments of the present disclosure may render transparent primitives T₁ and T₂ in an order that is according to a descending order based on their respective values of depth. For example, since the value of depth of transparent primitive T₂ is greater than that of transparent primitive T₁, embodiments of the present disclosure will render transparent primitive T₂ first at the particular pixel before rendering transparent primitive T₁ at that pixel. When transparent primitives T₁-T₉ are OIT primitives, meaning in rendering a given pixel with some or all of the transparent primitives T₁-T₉ the order in which some or all of the transparent primitives T₁-T₉ are processed is independent of the order in which these transparent primitives are received for processing (i.e., the incoming order of the transparent primitives does not matter), embodiments of the present disclosure may render transparent primitives T₁ and T₂ in an order that is independent of the descending order based on their respective values of depth. For example, embodiments of the present disclosure may render transparent primitive T₁ first at the particular pixel before rendering transparent primitive T₂ at that pixel if transparent primitive T₁ is received before transparent primitive T₂ in a sequence.

### EXAMPLE ALGORITHMS

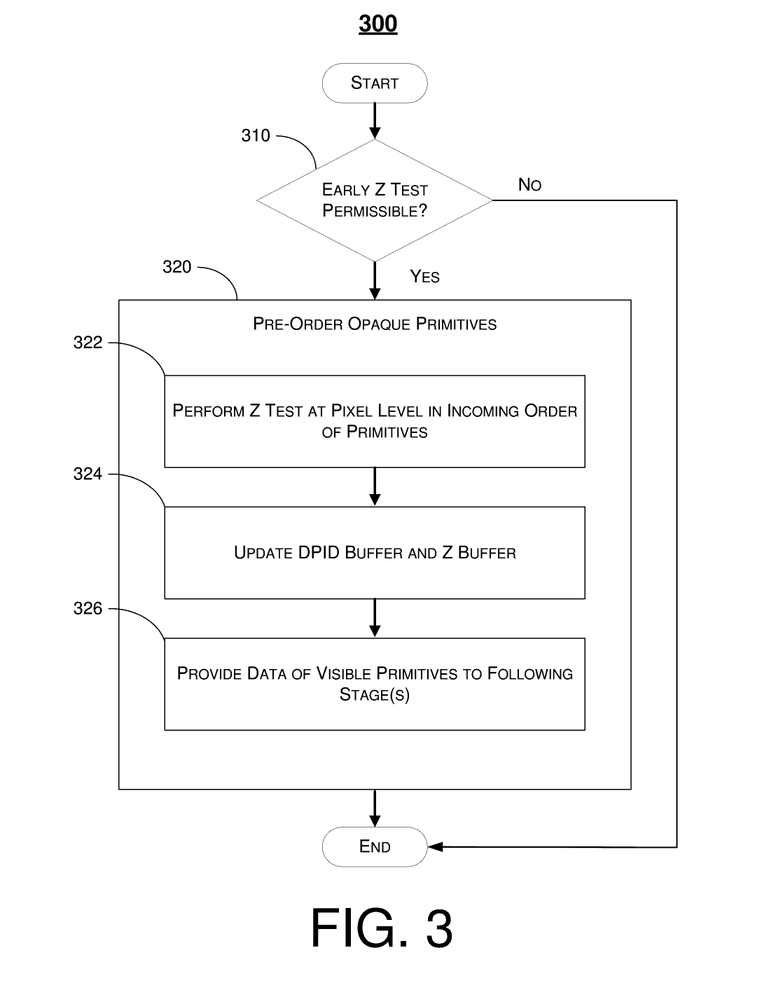

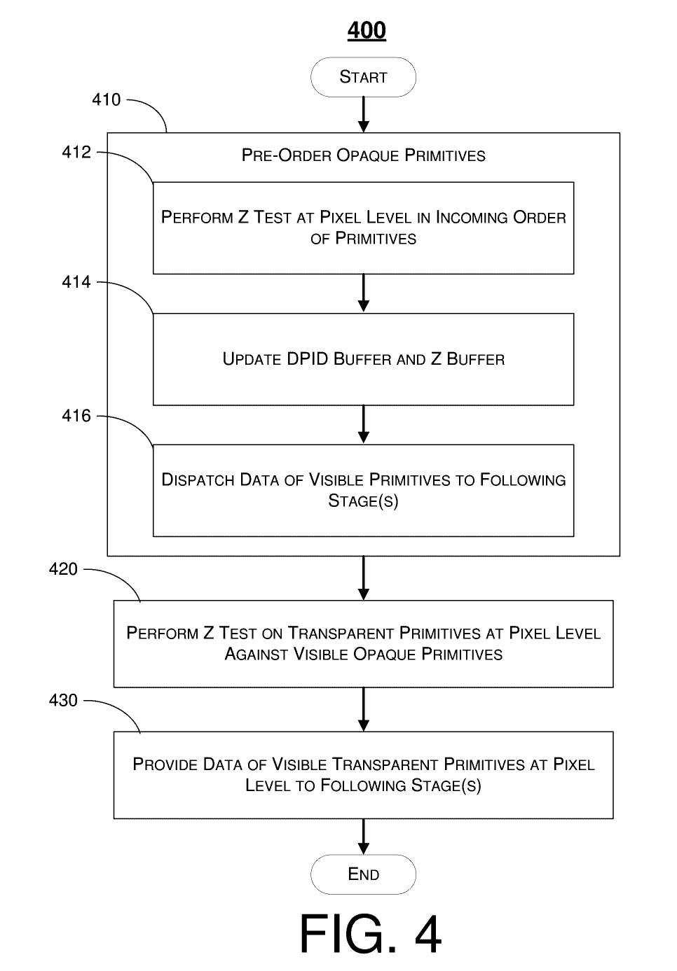

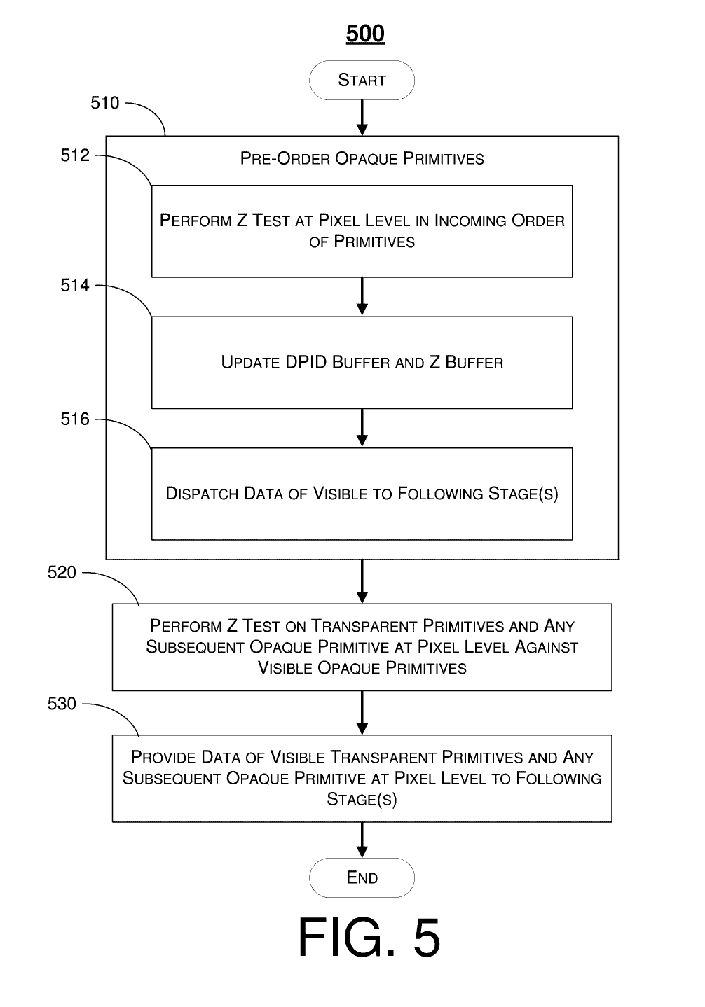

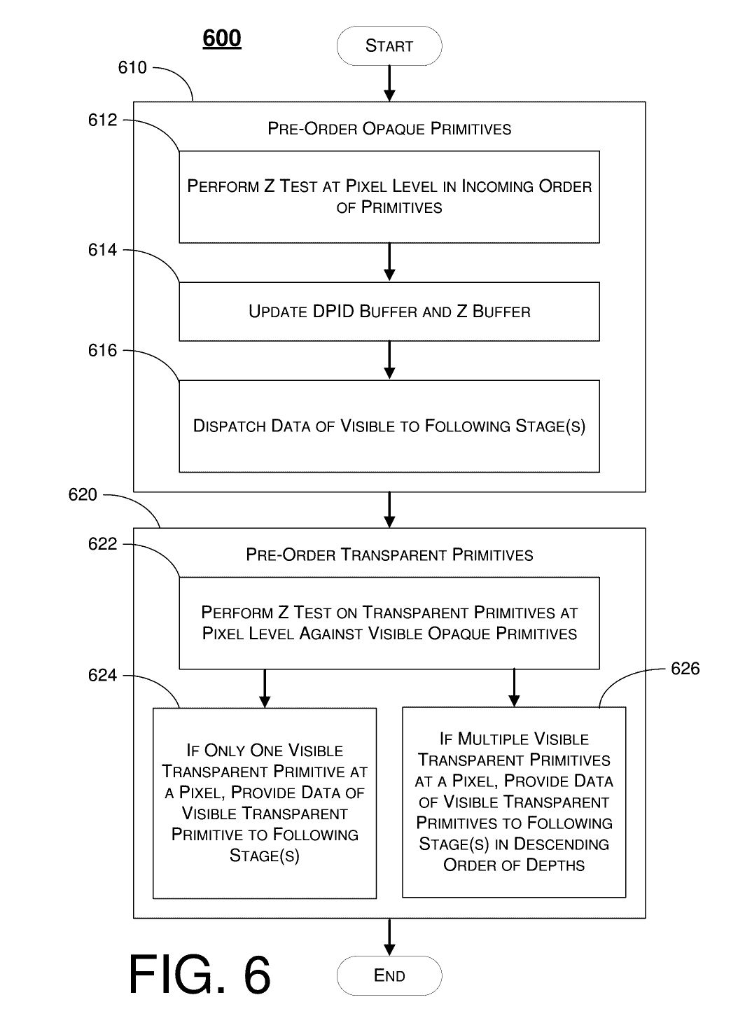

FIG. 3, FIG. 4, FIG. 5 and FIG. 6 show flowcharts of example algorithms 300, 400, 500 and 600, respectively, in accordance with embodiments of the present disclosure. Each of example algorithms 300, 400, 500 and 600 may be utilized for one or more scenarios including, but not limited to, Scenario 1, Scenario 2, Scenario 3 and example scenario 200. Each of example algorithms 300, 400, 500 and 600 may be implemented in and executed by example device 110 of FIG. 1. For illustrative purposes, the following description of each of example algorithms 300, 400, 500 and 600 is provided in the context of example device 110 implementing the respective example algorithm.

Example algorithm 300 addresses the scenario (e.g., Scenario 1) in which the primitives to be processed, e.g., by example device 110, include only opaque primitives and no transparent primitive. In general, the opaque primitives are processed in two passes by example algorithm 300. In the first pass the control circuit 120 of example device 110 may perform a Z test on the opaque primitives for each pixel of the bin to determine, for each pixel, which of the opaque primitives is the visible primitive, e.g., having the smallest value of depth at that pixel. For each pixel of the bin, control circuit 120 may record or otherwise store the identification (ID) of the visible primitive in DPID buffer 130 of example device 110. For each pixel of the bin, control circuit 120 may record or otherwise store the value of depth of the visible primitive in a Z buffer of example device 110 (not shown in FIG. 1). In performing the Z test for each pixel, control circuit 120 may compare the value of depth that is stored in the Z buffer for the pixel with the value of depth of each primitive that corresponds to that pixel. If the value of depth of a given primitive that corresponds to the primitive is greater than or equal to the value of depth of the visible primitive, which is stored in the Z buffer for the give pixel, no update to the value of depth for that pixel is made. On the other hand, if the value of depth of a given primitive that corresponds to the primitive is less than the value of depth of the visible primitive, which is stored in the Z buffer for the give pixel, then the value of depth stored in the Z buffer for that pixel is updated with the value of depth of the given primitive which is now the new visible primitive for that pixel. Thus, after the first pass the DPID buffer 130 stores the IDs of the visible primitives for all the pixels of the bin. It is possible that the same primitive may be the visible primitive for more than one pixel of the bin. Likewise, after the first pass the Z buffer stores the values of depth of the visible primitives for all the pixels of the bin. In the second pass the control circuit 120 may dispatch or otherwise provide the IDs of the visible primitives in batches, e.g., waves of 64 pixels, to a subsequent stage for rendering of the pixels.

It is notable that example algorithm 300 requires the use of early Z test. In cases where early Z test is not allowed or not available for use, then example algorithm 300 may render the primitives one by one, e.g., in a sequential order in which the primitives are received by control circuit 120 from an application or application programmable interface (API). That is, the two-pass operations described above will not be performed.

Example algorithm 300 may include one or more operations, actions, or functions as illustrated by one or more of blocks 310 and 320. Although illustrated as discrete blocks, various blocks may be divided into additional blocks, combined into fewer blocks, or eliminated, depending on the desired implementation. Example algorithm 300 may be implemented by control circuit 120 of example device 110. For illustrative purposes, the operations described below are performed by control circuit 120 of example device 110. Example algorithm 300 may begin at block 310.

At 310, control circuit 120 may determine whether early Z test is permissible. In an event that it is determined that early Z test is not permissible, example algorithm 300 ends. Otherwise, in an even that it is determined that early Z test is permissible, example algorithm 300 proceeds to block 320.

At 320, control circuit 120 may perform pre-ordering of the primitives which are all opaque primitives. In doing so, example algorithm 300 may involve control circuit 120 performing a number of operations pertaining to sub-blocks 322, 324 and 326 starting at sub-block 322.

At 322, control circuit 120 may perform Z test at pixel level, e.g., for each pixel of the bin, on the primitives in an incoming order in which the primitives are received by control circuit 120. Sub-block 322 may be followed by sub-block 324. At 324, control circuit 120 may update DPID buffer 130 with IDs of the visible primitives. Control circuit 120 may also update Z buffer with values of depth of the visible primitives. Sub-block 324 may be followed by sub-block 326.

At 326, control circuit 120 may dispatch or otherwise provide data associated with the visible primitives, including their IDs, to one or more following stages, e.g., for rendering of the pixels of the bin. In some embodiments, control circuit 120 may dispatch or otherwise provide at least the IDs of the visible primitives in batches such that a batch of multiple pixels of the pixels of the bin are rendered at a time.

In the context of example scenario 200, assuming none of the transparent primitives T₁-T₉ exists, example algorithm 300 will render the particular pixel with data associated with opaque primitive O₁ but not data associated with the other opaque primitives O₂-O₇.

Example algorithm 400 addresses the scenario (e.g., Scenario 2) in which the primitives to be processed, e.g., by example device 110, include both opaque primitives and transparent primitives, with all the transparent primitives received, e.g., from an API, after the opaque primitives and stored in a correct sequence in which the transparent primitives are to be processed. That is, the assumption is that the transparent primitives are received in an incoming order that is pre-sorted, or un-sorted but the application or API expects the results to be the same as rendered in an immediate, render-in-the-order-as-you-receive-it mode. If the transparent primitives are pre-sorted, example algorithm 400 may process the transparent primitives after processing the opaque primitives. Nevertheless, a scenario like example scenario 200 is possible where some of

the transparent and opaque primitives are interleaved in terms of their depths relative to the image plane at one or more pixels of the bin.

In general, example algorithm 400 first processes the opaque primitives at pixel level, e.g., for each pixel of the bin, based on example algorithm 300. After the opaque primitives are processed for the entire bin, DIPD buffer 130, which has a size the same as that of the bin, will store the ID of the visible opaque primitives for each pixel of the bin. Likewise, the Z buffer, which has a size the same as that of the bin, will store value of depth of the visible opaque primitives for each pixel of the bin. For subsequent primitives corresponding to each pixel of the bin, which are transparent primitives, example algorithm 400 may process them one by one in a sequential order in which the transparent primitives are received, e.g., from an API. If a transparent primitive being processed has a value of depth the same as or greater than the value of depth of the visible opaque primitive stored in the Z buffer for that pixel, control circuit 120 may disregard or discard it. If, on the other hand, transparent primitive being processed has a value of depth less than the stored value of depth of the visible opaque primitive, control circuit 120 may dispatch or otherwise provide at least the ID of that transparent primitive immediately for rendering. Example algorithm 400 may repeat this process for each pixel until all the transparent primitives have been processed.

Example algorithm 400 may include one or more operations, actions, or functions as illustrated by one or more of blocks 410, 420 and 430. Although illustrated as discrete blocks, various blocks may be divided into additional blocks, combined into fewer blocks, or eliminated, depending on the desired implementation. Example algorithm 400 may be implemented by control circuit

120 of example device 110. For illustrative purposes, the operations described below are performed by control circuit 120 of example device 110. Example algorithm 400 may begin at block 410.

At 410, control circuit 120 may perform pre-ordering of the opaque primitives. In doing so, example algorithm 400 may involve control circuit 120 performing a number of operations pertaining to sub-blocks 412, 414 and 416 and starting at sub-block 412.

At 412, control circuit 120 may perform Z test at pixel level, e.g., for each pixel of the bin, on the primitives in an incoming order in which the primitives are received by control circuit 120. Sub-block 412 may be followed by sub-block 414.

At 414, control circuit 120 may update DPID buffer 130 with IDs of the visible primitives. Control circuit 120 may also update Z buffer with values of depth of the visible primitives. Sub-block 414 may be followed by sub-block 416.

At 416, control circuit 120 may dispatch or otherwise provide data associated with the visible primitives, including their IDs, to one or more following stages, e.g., for rendering of the pixels of the bin. In some embodiments, control circuit 120 may dispatch or otherwise provide at least the IDs of the visible primitives in batches such that a batch of multiple pixels of the pixels of the bin are rendered at a time. Subsequent to sub-block 416, block 410 may be followed by block 420.

At 420, control circuit 120 may perform Z test on the transparent primitives at pixel level against the visible opaque primitive for each pixel of the bin. If a transparent primitive being processed has a value of depth the same

as or greater than the value of depth of the visible opaque primitive stored in the Z buffer for that pixel, control circuit 120 may disregard or discard it. If, on the other hand, the transparent primitive being processed has a value of depth less than the stored value of depth of the visible opaque primitive, control circuit 120 may dispatch or otherwise provide at least the ID of that transparent primitive immediately for rendering. Block 420 may be followed by block 430.

At 430, control circuit 120 may dispatch or otherwise provide data associated with the visible transparent primitive, including their IDs, to one or more following stages, e.g., for rendering of a given pixel, if such visible transparent primitive exists at that pixel. Control circuit 120 may do this for multiple visible transparent primitives at the same pixel in the order in which these visible transparent primitives are processed or received, e.g., from an API.

In the context of example scenario 200, among the opaque primitives O₁-O₇, example algorithm 400 will render the particular pixel with data associated with opaque primitive O₁ but not data associated with the other opaque primitives O₂-O₇. Also, between the two visible transparent primitives T₁ and T₂, example algorithm 400 may render the pixel with data associated with transparent primitives T₁ and T₂ in an order in which these two visible transparent primitives are received.

Example algorithm 500 addresses the scenario (e.g., Scenario 3) in which the primitives to be processed, e.g., by example device 110, include both opaque primitives and transparent primitives, with all the transparent primitives received, e.g., from an API, after the opaque primitives and with one or more opaque primitive actually come after the first transparent primitive is received. The different between the scenario addressed by example algorithm 500 and the scenario addressed by example algorithm 400 is the receipt of one or more opaque primitives after the first transparent primitive has been received and processed. In terms of execution example algorithm 500 is similar to example algorithm 400.

In general, example algorithm 500 first processes the opaque primitives at pixel level, e.g., for each pixel of the bin, based on example algorithm 300. After the opaque primitives are processed for the entire bin, DIPD buffer 130, which has a size the same as that of the bin, will store the ID of the visible opaque primitives for each pixel of the bin. Likewise, the Z buffer, which has a size the same as that of the bin, will store value of depth of the visible opaque primitives for each pixel of the bin. For subsequent primitives corresponding to each pixel of the bin, which are transparent primitives, example algorithm 500 may process them one by one in a sequential order in which the transparent primitives are received, e.g., from an API. If a transparent primitive being processed has a value of depth the same as or greater than the value of depth of the visible opaque primitive stored in the Z buffer for that pixel, control circuit 120 may disregard or discard it. If, on the other hand, transparent primitive being processed has a value of depth less than the stored value of depth of the visible opaque primitive, control circuit 120 may dispatch or otherwise provide at least the ID of that transparent primitive immediately for rendering. Example algorithm 500 may repeat this process for each pixel until all the transparent primitives have been processed.

In the scenario addressed by example algorithm 500 the visible opaque primitive identified previously may not be the actual visible primitive for the respective pixel in view of the one or more later-received opaque primitives. This is because, with respect to the given pixel, any of the one or more later-received opaque primitives may be closer to the image plane that the previously-identified visible opaque primitive. In such case, irrespective of the rendering of the previously-identified visible opaque primitive and any visible transparent primitive at that pixel, example algorithm 500 will render the later-identified visible opaque primitive for that pixel.

Example algorithm 500 may include one or more operations, actions, or functions as illustrated by one or more of blocks 510, 520 and 530. Although illustrated as discrete blocks, various blocks may be divided into additional blocks, combined into fewer blocks, or eliminated, depending on the desired implementation. Example algorithm 500 may be implemented by control circuit 120 of example device 110. For illustrative purposes, the operations described below are performed by control circuit 120 of example device 110. Example algorithm 500 may begin at block 510.

At 510, control circuit 120 may perform pre-ordering of the opaque primitives. In doing so, example algorithm 500 may involve control circuit 120 performing a number of operations pertaining to sub-blocks 512, 514 and 516 and starting at sub-block 512.

At 512, control circuit 120 may perform Z test at pixel level, e.g., for each pixel of the bin, on the primitives in an incoming order in which the primitives are received by control circuit 120. Sub-block 512 may be followed by sub-block 514.

At 514, control circuit 120 may update DPID buffer 130 with IDs of the visible primitives. Control circuit 120 may also update Z buffer with values of depth of the visible primitives. Sub-block 514 may be followed by sub-block 516.

At 516, control circuit 120 may dispatch or otherwise provide data associated with the visible primitives, including their IDs, to one or more following stages, e.g., for rendering of the pixels of the bin. In some embodiments, control circuit 120 may dispatch or otherwise provide at least the IDs of the visible primitives in batches such that a batch of multiple pixels of the pixels of the bin are rendered at a time. Subsequent to sub-block 516, block 510 may be followed by block 520.

At 520, control circuit 120 may perform Z test on the transparent primitives and any later-received opaque primitive at pixel level against the visible opaque primitive for each pixel of the bin. If a transparent primitive or any later-received opaque primitive being processed has a value of depth the same as or greater than the value of depth of the visible opaque primitive stored in the Z buffer for that pixel, control circuit 120 may disregard or discard it. If, on the other hand, the transparent primitive any later-received opaque primitive being processed has a value of depth less than the stored value of depth of the visible opaque primitive, control circuit 120 may dispatch or otherwise provide at least the ID of that transparent primitive or the later-received opaque primitive immediately for rendering. Block 520 may be followed by block 530.

At 530, control circuit 120 may dispatch or otherwise provide data associated with the visible transparent primitive or the later-received opaque primitive, including their IDs, to one or more following stages, e.g., for rendering of a given pixel, if such visible transparent primitive or later-received visible opaque primitive exists at that pixel. Control circuit 120 may do this for multiple visible transparent primitives and multiple later-received opaque primitives at the same pixel in the order in which these visible transparent and/or opaque primitives are processed or received, e.g., from an API.

In the context of example scenario 200, among the opaque primitives O₁-O₇, example algorithm 500 will render the particular pixel with data associated with opaque primitive O₁ but not data associated with the other opaque primitives O₂-O₇. Also, between the two visible transparent primitives T₁ and T₂, example algorithm 500 may render the pixel with data associated with transparent primitives T₁ and T₂ in an order in which these two visible transparent primitives are received.

Example algorithm 600 addresses the scenario (e.g., Scenario 2) in which the primitives to be processed, e.g., by example device 110, include both opaque primitives and transparent primitives, with all the transparent primitives received, e.g., from an API, after the opaque primitives where the transparent primitives need to be sorted into a correct order in which the transparent primitives are to be processed before being dispatched for rendering. That is, the assumption is that additional sorting, or pre-ordering, of the transparent primitives is necessary. Example algorithm 600 may process the transparent primitives after processing the opaque primitives. Nevertheless, a scenario like example scenario 200 is possible where some of the transparent and opaque primitives are interleaved in terms of their depths relative to the image plane at one or more pixels of the bin.

In general, the opaque primitives are processed in two passes by example algorithm 600. Subsequently, the transparent primitives are processed in two passes by example algorithm 600. For the opaque primitives, in the first pass the control circuit 120 of example device 110 may perform a Z test on the opaque primitives for each pixel of the bin to determine, for each pixel, which of the opaque primitives is the visible opaque primitive, e.g., having the smallest value of depth at that pixel. For each pixel of the bin, control circuit 120 may record or otherwise store the ID of the visible opaque primitive in DPID buffer 130 of example device 110. For each pixel of the bin, control circuit 120 may record or otherwise store the value of depth of the visible opaque primitive in a Z buffer of device. In performing the Z test for each pixel, control circuit 120 may compare the value of depth that is stored in the Z buffer for the pixel with the value of depth of each primitive that corresponds to that pixel. If the value of depth of a given primitive that corresponds to the primitive is greater than or equal to the value of depth of the visible opaque primitive, which is stored in the Z buffer for the give pixel, no update to the value of depth for that pixel is made. On the other hand, if the value of depth of a given primitive that corresponds to the primitive is less than the value of depth of the visible opaque primitive, which is stored in the Z buffer for the give pixel, then the value of depth stored in the Z buffer for that pixel is updated with the value of depth of the given primitive which is now the new visible opaque primitive for that pixel. Thus, after the first pass the DPID buffer 130 stores the IDs of the visible opaque primitives for all the pixels of the bin. It is possible that the same primitive may be the visible opaque primitive for more than one pixel of the bin. Likewise, after the first pass the Z buffer stores the values of depth of the visible opaque primitives for all the pixels of the bin. In the second pass the control circuit 120 may dispatch or otherwise provide the IDs of the visible opaque primitives in batches, e.g., waves of 64 pixels, to a subsequent stage for rendering of the pixels.

For the transparent primitives, in the first pass the control circuit 120 of example device 110 may perform a Z test on the transparent primitives for each pixel of the bin to determine, for each pixel, which one or more of the transparent primitives is/are visible, e.g., having a smaller value of depth at that pixel than that of the visible opaque primitive. For each pixel of the bin, control circuit 120 may record or otherwise store the ID of the visible transparent primitive in DPID buffer 130 of example device 110. For each pixel of the bin, control circuit 120 may record or otherwise store the value of depth of the visible transparent primitive in a Z buffer of device. After the first pass the DPID buffer 130 stores the IDs of the visible transparent primitives for all the pixels of the bin. It is possible that the same transparent primitive may be the visible transparent primitive for more than one pixel of the bin. Likewise, after the first pass the Z buffer stores the values of depth of the visible transparent primitives for all the pixels of the bin. In the second pass the control circuit 120 may dispatch or otherwise provide the IDs of the visible transparent primitives in batches, e.g., waves of 64 pixels, to a subsequent stage for rendering of the pixels.

For each pixel of the bin, example algorithm 600 may involve the control circuit 120 determining whether one or more of the transparent primitives is/are visible, e.g., having a smaller value of depth at that pixel than that of the visible opaque primitive. When only one transparent primitive is visible vis-à-vis the visible opaque primitive at a given pixel, that one transparent primitive is rendered. When multiple transparent primitives are visible vis-à-vis the visible opaque primitive at a given pixel, example algorithm 600 may render those multiple transparent primitives in a descending order with respect to the depths of the multiple transparent primitives such that the pixel is rendered first with data associated with a first transparent primitive of the multiple transparent primitives and then with data associated with a second transparent primitive of the multiple transparent primitives, where a depth of the first transparent primitive is greater than a depth of the second transparent primitive but not greater than the depth of the visible primitive relative to the image plane at the pixel.

Example algorithm 600 may include one or more operations, actions, or functions as illustrated by one or more of blocks 610 and 620. Although illustrated as discrete blocks, various blocks may be divided into additional blocks, combined into fewer blocks, or eliminated, depending on the desired implementation. Example algorithm 600 may be implemented by control circuit 120 of example device 110. For illustrative purposes, the operations described below are performed by control circuit 120 of example device 110. Example algorithm 600 may begin at block 610.

At 610, control circuit 120 may perform pre-ordering of the opaque primitives. In doing so, example algorithm 600 may involve control circuit 120 performing a number of operations pertaining to sub-blocks 612, 614 and 616 and starting at sub-block 612.

At 612, control circuit 120 may perform Z test at pixel level, e.g., for each pixel of the bin, on the primitives in an incoming order in which the primitives are received by control circuit 120. Sub-block 612 may be followed by sub-block 614.

At 614, control circuit 120 may update DPID buffer 130 with IDs of the visible primitives. Control circuit 120 may also update Z buffer with values of depth of the visible primitives. Sub-block 614 may be followed by sub-block 616.

At 616, control circuit 120 may dispatch or otherwise provide data associated with the visible primitives, including their IDs, to one or more following stages, e.g., for rendering of the pixels of the bin. In some embodiments, control circuit 120 may dispatch or otherwise provide at least the IDs of the visible primitives in batches such that a batch of multiple pixels of the pixels of the bin are rendered at a time. Subsequent to sub-block 616, block 610 may be followed by block 620.

At 620, control circuit 120 may perform pre-ordering of the transparent primitives. In doing so, example algorithm 600 may involve control circuit 120 performing a number of operations pertaining to sub-blocks 622, 624 and 626 and starting at sub-block 622.

At 622, control circuit 120 may perform Z test at pixel level, e.g., for each pixel of the bin, on the transparent primitives against the visible opaque primitive for that pixel. Sub-block 622 may be alternatively followed by sub-block 624 or sub-block 626.

At 624, if one transparent primitive is visible vis-à-vis the visible opaque primitive at a given pixel, control circuit 120 may dispatch or otherwise provide data associated with the visible transparent primitive, including its ID, to one or more following stages, e.g., for rendering of the pixel of the bin using data associated with the one transparent primitive.

At 626, if multiple transparent primitives are visible vis-à-vis the visible opaque primitive at a given pixel, control circuit 120 may dispatch or otherwise provide data associated with the visible transparent primitives, including their ID, to one or more following stages, e.g., for rendering of the pixel of the bin using data associated with the multiple transparent primitives, one at a time in a descending order with respect to the depths of the multiple transparent primitives such that the pixel is rendered first with data associated with a deeper transparent primitive of the multiple visible transparent primitives and then with data associated with a shallower transparent primitive of the multiple visible transparent primitives.

In the context of example scenario 200, among the opaque primitives O₁-O₇, example algorithm 600 will render the particular pixel with data associated with opaque primitive O₁ but not data associated with the other opaque primitives O₂-O₇. Also, between the two visible transparent primitives T₁ and T₂, example algorithm 600 may render the pixel first with data associated with transparent primitive T₂ (the deeper transparent primitive of the two) followed by data associated with transparent primitive T₁ (the shallower transparent primitive of the two).

Example Implementations

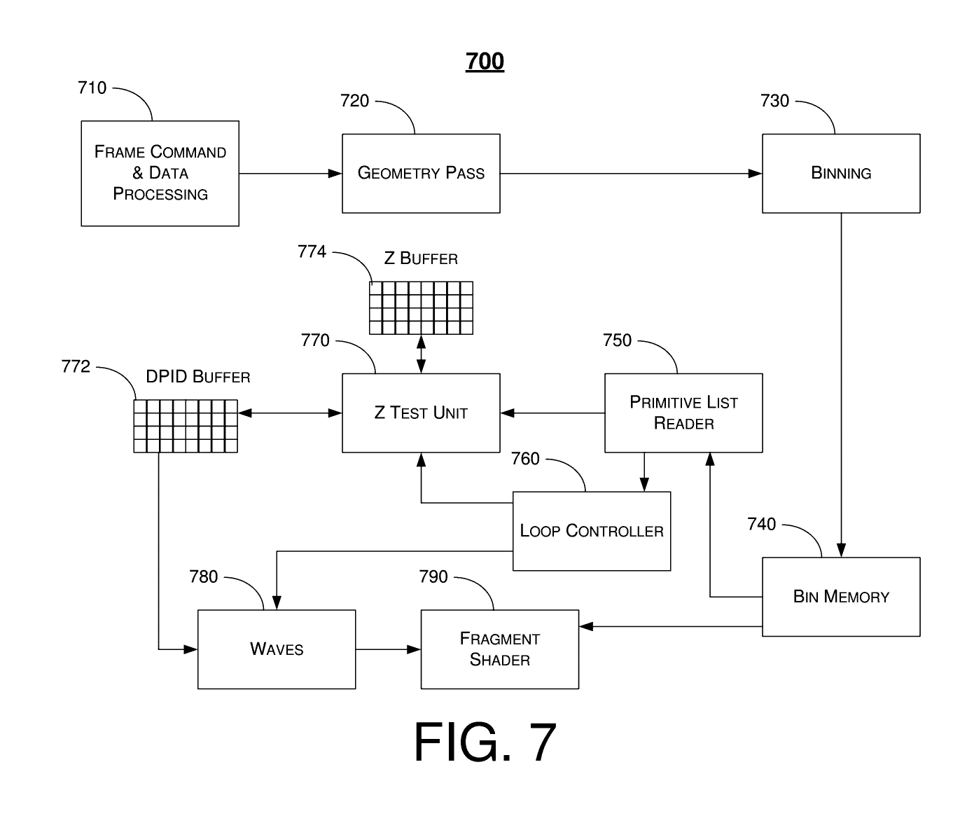

FIG. 7 is a block diagram of an example scheme 700 configured to execute the example algorithms of the present disclosure. Example scheme 700 may perform various functions related to techniques, methods and systems described herein, including example algorithms 300, 400, 500 and 600 described above as well as example processes 900, 1000 and 1100 described below. Example scheme 700 may be implemented in example device 110 described above as well as example apparatus 800 described below. Example scheme 700 may be implemented by hardware, software, middleware, firmware, or any combination thereof.

In some embodiments, example scheme 700 may be implemented in a portable electronics apparatus such as, for example, a smartphone, a personal digital assistant (PDA), a camera, a camcorder or a computing device such as a tablet computer, a laptop computer, a notebook computer, a wearable device and the like, which is equipped with imaging graphics processing device. In such case, example scheme 700 may include at least those components shown in FIG. 7.

In some other embodiments, example scheme 700 may be implemented in a GPU in the form of an IC, chip, chipset or an assembly of one or more chips and a printed circuit board (PCB), which may be implementable in a portable electronics apparatus such as, for example, a smartphone, a PDA, a camera, a camcorder or a computing device such as a tablet computer, a laptop computer, a notebook computer, a wearable device and the like, which is equipped with a graphics processing device.

As shown in FIG. 7, example scheme 700 includes a number of blocks. Each block in example scheme 700 may represent a function, an operation or a device configured to perform a certain operation. Description of each component in example scheme 700 is provided below.

Frame command and data processing 710 may refer to a function (and associated circuitry) which may be a standard operation of an API. For example, frame command and data processing 710 may refer to an API extracting from an image frame data of the primitives of the frame, including their graphic data and render status.

Geometry pass 720 may refer to a function (and associated circuitry) that, for each extracted primitive, calculates its vertex values and records its graphic attributes, e.g., translucency and texture.

Binning 730 may refer to a function (and associated circuitry) that divides the frame, e.g., frame 170, into smaller regions called bins or tiles, e.g., each sized with 32 pixels by 32 pixels. Binning 730 may also assign to each bin a list of primitives that intersect with the pixels of the bin. The order of primitives in the list may be determined by binning 730.

Bin memory 740 may refer to a memory that stores the list of primitives for the bins, e.g., in a look-up table format. As each bin is associated with a respective list of primitives, there may be multiple instances of bin memory 740 to accommodate the multiple bins of a frame.

Fragment shader 790 may refer to a stage of a rendering engine for rendering pixels of the bin. Fragment shader 790 may determine graphic attributes such as color, shading, texture, etc. of each pixel being rendered based on data of the corresponding visible primitive(s). Fragment shader 790 may also blend a new primitive to existing primitives at a pixel by mixing the graphic attributes from the primitives. Fragment shader 790 may work in two modes: batch mode and pixel mode. When in batch mode, fragment shader 790 may render multiple pixels at a time. When in pixel mode, Fragment shader 790 may render the pixel specified and no other pixels.

Waves 780 may receive or otherwise retrieve primitive IDs of pixels to be rendered in batches called waves, such that a rendering engine, e.g., fragment shader 790, may work in batch mode. Fragment shader 790 may take one wave of pixels at a time and execute single-instruction-multiple-data (SIMD) commands on the multiple pixels in the wave. For example, for a 32-pixel-by-32-pixel bin size, up to 16 waves (SIMD-64 for each wave) may be dispatched.

Functions of the remaining components of example scheme 700, namely primitive list reader 750, loop controller 760, Z test unit 770, DPID buffer 772 and Z buffer 774, may vary in different scenarios by implementing different algorithms. Therefore, description of these components is provided in the context of various scenarios. For example, example algorithm 300 may be implemented in example scheme 700 with respect to Scenario 1. Likewise, example algorithm 400 may be implemented in example scheme 700 with respect to Scenario 2 when the transparent primitives do not need to be sorted. Similarly, example algorithm 500 may be implemented in example scheme 700 with respect to Scenario 3. Additionally, example algorithm 600 may be implemented in example scheme 700 with respect to Scenario 2 when the transparent primitives need to be sorted.

The following description of primitive list reader 750, loop controller 760, Z test unit 770, DPID buffer 772 and Z buffer 774 pertains to implementation of example algorithm 300 with respect to Scenario 1.

For a bin being processed, e.g., one of bins 180(1,1)-180(Q,R) of frame 170, primitive list reader 750 may receive or otherwise retrieve data associated with a respective primitive list of one or more primitives from bin memory 750. Primitive list reader 750 may start with a given pixel of the bin, and process each primitive in the primitive list in a sequential order for the pixel. After all the primitives are processed for the given pixel, primitive list reader 750 may repeat the same for another pixel of the bin until the primitives corresponding to all the pixels of the bin have been processed.

When processing the primitives for a given pixel, primitive list reader 750 may receive or otherwise retrieve data associated with a first primitive in sequence in the primitive list and determine whether or not the first primitive intersects with the pixel. If it is determined that the first primitive does not intersect with the pixel, primitive list reader 750 may disregard that primitive. On the other hand, if it is determined that the first primitive intersects with the pixel, primitive list reader 740 may forward data associated with the first primitive to Z test unit 770. Primitive list reader 750 may then receive or otherwise retrieve data associated with a second primitive in sequence in the primitive list, and determine whether or not the second primitive intersects with the pixel, and either disregard the second primitive or forward data associated with the second primitive to Z test unit 770. Primitive list reader 750 may sequentially repeat the same for all the primitives in the primitive list to conclude the processing of the primitive list for each pixel of the bin. In some embodiments, when forwarding data associated with a particular primitive to Z test unit 770, primitive list reader 750 may forward the following data: the coordinates of the pixel (e.g., X and Y coordinates of the pixel in the bin), the ID of the primitive (PID), the value of depth of the primitive at the pixel (Z value), and whether the primitive being processed is opaque or transparent (O/T flag).

In addition, primitive list reader 750 may report to loop controller 760 upon completing the above described processing for all the pixels of a bin. Z buffer 774 may be configured to record or otherwise store values of depth of the pixels of a bin, with one value of depth stored for each pixel of the bin. Thus, Z buffer 774 may be sized the same as a bin. For example, Z buffer 774 may be configured to store the values of depth for 1024 pixels when each bin of bins 180(1,1)-180(Q,R) of frame 170 has a dimension of 32 pixels by 32 pixels.

DPID buffer 772 may be configured to record or otherwise store PIDs of the pixels of a bin, with one PID stored for each pixel of the bin. Thus, DPID buffer 772 may be sized the same as a bin. For example, DPID buffer 772 may be configured to store the values of depth for 1024 pixels when each bin of bins 180(1,1)-180(Q,R) of frame 170 has a dimension of 32 pixels by 32 pixels. DIPD buffer 772 may be read by waves 780 when waves 780 is so instructed by loop controller 760.

At the beginning of processing for a bin, Z test unit 770 may set all the PIDs in DPID buffer 772 to null and set all the values of depth in Z buffer 774 to a maximum depth (usually represented by a floating number 1). Z test unit 770 may perform a Z test every time it receives a set of data from primitive list reader 750. When processing a primitive for a given pixel, primitive list reader 750 may check the primitive at the pixel to determine whether or not the primitive intersects with, or corresponds to, the pixel. If it is determined that the primitive does not intersect with the pixel, primitive list reader 750 may disregard that primitive. If, however, it is determined that the primitive does intersect with the pixel, primitive list reader 750 may immediately send data associated with the primitive to Z test unit 770.

For example, when primitive list reader 750 determines that a primitive intersects with a given pixel of a bin, Z test unit 770 may receive from primitive list reader 750 the following data associated with the primitive with respect to the pixel: the coordinates of the pixel (e.g., X and Y coordinates of the pixel in the bin), the ID of the primitive (PID), the value of depth of the primitive at the pixel (Z value), and whether the primitive being processed is opaque or transparent (O/T flag).

Z test unit 770 may first check the O/T flag to determine whether the primitive the data of which being forwarded by primitive list reader 750 is opaque or transparent. In Scenario 1 there are opaque primitives but no transparent primitives. In Scenario 2 and Scenario 3 there are opaque primitives as well as transparent primitives. If the O/T flag indicates the incoming primitive is an opaque primitive, Z test unit 770 may perform a Z test described below.

Using the X and Y coordinates of the pixel, Z test unit 770 may fetch the stored value of depth for the corresponding pixel from Z buffer 774, and compare the stored value of depth with that of the incoming primitive, which is forwarded by primitive list reader 750. If it is determined that the value of depth of the incoming primitive is less than the stored value of depth, Z test unit 770 may update the value of depth for the pixel in concern by recording or otherwise storing the value of depth of the incoming primitive for that pixel in Z buffer 774. In addition, Z test unit 770 may update the PID for the pixel by recording or otherwise storing the PID of the incoming primitive for that pixel in DPID buffer 772. Thus, both Z buffer 774 and DPID buffer 772 are updated for the pixel, while the stored values for other pixels in both Z buffer 774 and DPID buffer 772 remain unchanged. On the other hand, if it is determined that the value of depth of the incoming primitive is not less than the stored value of depth, then the stored value of depth in Z buffer 774 and stored PID in DPID buffer 772 for the pixel in concern are not updated by Z test unit 770.

Upon completion of processing of the pixels of a bin, primitive list reader 750 may signal loop controller 760, and loop controller 760 may signal waves 780 dispatch or otherwise provide the stored PIDs in DPID buffer 772 in batches, or waves, to waves 760. That is, waves 780 may retrieve PIDs from DPID buffer 772 in batches, or waves, and trigger fragment shader 790 to render the pixels of the bin in batch mode according to the PIDs received or otherwise retrieved from DPID buffer 772.

The following description of primitive list reader 750, loop controller 760, Z test unit 770, DPID buffer 772 and Z buffer 774 pertains to implementation of example algorithm 400 with respect to Scenario 2. In this scenario, the opaque primitives are processed first as described above with respect to Scenario 1, and the transparent primitives are subsequently processed.

For a bin being processed, e.g., one of bins 180(1,1)-180(Q,R) of frame 170, primitive list reader 750 may receive or otherwise retrieve data associated with a respective primitive list of one or more opaque primitives from bin memory 750. Primitive list reader 750 may start with a given pixel of the bin, and process each primitive in the primitive list in a sequential order for the pixel. After all the opaque primitives are processed for the given pixel, primitive list reader 750 may repeat the same for another pixel of the bin until the opaque primitives corresponding to all the pixels of the bin have been processed.

Upon completing the above process for opaque primitives for the pixels of the bin, primitive list reader 750 may signal loop controller 760 to inform loop controller 760 of the completion of processing of opaque primitives. Loop controller 760 may in turn signal waves 780 to receive or otherwise retrieve from DPID buffer 772 the PIDs of visible opaque primitives for rendering of the pixels of the bin in batch mode by fragment shader 790. At this stage the rendered primitives are opaque primitives.

After fragment shader 790 finishes the rendering of the opaque primitives, loop controller 760 may instruct primitive list reader 750 to further process transparent primitives for pixels of the bin. Similar to how the opaque primitives are processed, primitive list reader 750 may receive or otherwise retrieve data associated with a respective primitive list of one or more transparent primitives from bin memory 740. Primitive list reader 750 may start with a given pixel of the bin, and process each primitive in the primitive list in a sequential order for the pixel. After all the transparent primitives are processed for the given pixel, primitive list reader 750 may repeat the same for another pixel of the bin until the transparent primitives corresponding to all the pixels of the bin have been processed.

When processing the opaque primitives for a given pixel, primitive list reader 750 may receive or otherwise retrieve data associated with a first opaque primitive in sequence in the primitive list of one or more opaque primitives and determine whether or not the first opaque primitive intersects with the pixel. If it is determined that the first opaque primitive does not intersect with the pixel, primitive list reader 750 may disregard that opaque primitive. On the other hand, if it is determined that the first opaque primitive intersects with the pixel, primitive list reader 740 may forward data associated with the first opaque primitive to Z test unit 770. Primitive list reader 750 may then receive or otherwise retrieve data associated with a second opaque primitive in sequence in the primitive list of one or more opaque primitives, and determine whether or not the second opaque primitive intersects with the pixel, and either disregard the second opaque primitive or forward data associated with the second opaque primitive to Z test unit 770. Primitive list reader 750 may sequentially repeat the same for all the opaque primitives in the primitive list to conclude the processing of the opaque primitive list for each pixel of the bin.

Similarly, when processing the transparent primitives for a given pixel, primitive list reader 750 may receive or otherwise retrieve data associated with a first transparent primitive in sequence in the primitive list of one or more transparent primitives and determine whether or not the first transparent primitive intersects with the pixel. If it is determined that the first transparent primitive does not intersect with the pixel, primitive list reader 750 may disregard that transparent primitive. On the other hand, if it is determined that the first transparent primitive intersects with the pixel, primitive list reader 740 may forward data associated with the first transparent primitive to Z test unit 770. Primitive list reader 750 may then receive or otherwise retrieve data associated with a second transparent primitive in sequence in the primitive list of one or more transparent primitives, and determine whether or not the second transparent primitive intersects with the pixel, and either disregard the second transparent primitive or forward data associated with the second transparent primitive to Z test unit 770. Primitive list reader 750 may sequentially repeat the same for all the transparent primitives in the primitive list to conclude the processing of the transparent primitive list for each pixel of the bin.

In some embodiments, when forwarding data associated with a particular primitive to Z test unit 770, primitive list reader 750 may forward the following data: the coordinates of the pixel (e.g., X and Y coordinates of the pixel in the bin), the ID of the primitive (PID), the value of depth of the primitive at the pixel (Z value), and whether the primitive being processed is opaque or transparent (O/T flag).

In addition, primitive list reader 750 may report to loop controller 760 upon completing the above described processing for all the pixels of a bin.

Z test unit 770 may first check the O/T flag to determine whether the primitive the data of which being forwarded by primitive list reader 750 is opaque or transparent. In the case where the O/T flag indicates an incoming primitive is an opaque primitive, Z test unit 770 may function as described above with respect to example algorithm 300 in Scenario 1. In the case where the O/T flag indicates the incoming primitive is a transparent primitive, Z test unit 770 may perform a Z test as described below.

Using the X and Y coordinates of the pixel, Z test unit 770 may fetch the stored value of depth for the corresponding pixel from Z buffer 774, and compare the stored value of depth with that of the incoming transparent primitive, which is forwarded by primitive list reader 750. If it is determined that the value of depth of the incoming transparent primitive is less than the stored value of depth, Z test unit will not update Z buffer 774 or DPID buffer 772. Instead, Z test unit 770 may signal loop controller 760 to indicate that the pixel in concern needs to be immediately rendered using data associated with the transparent primitive in concern. Loop controller 760 may pass the coordinates of the pixel and data associated with the transparent primitive to fragment shader 790 for rendering of that pixel. On the other hand, if it is determined that the value of depth of the incoming primitive is not less than the stored value of depth, Z buffer unit 774 may disregard the transparent primitive. The stored value of depth in Z buffer 774 and stored PID in DPID buffer 772 for the pixel in concern are also not updated by Z test unit 770.

In the case where both opaque and transparent primitives are present for rendering of the pixels of the bin, loop controller 760 may signal fragment shader 790 to render the pixels in batch mode according to batches, or waves, of PIDs from DPID buffer 772 (as provided by waves 780) when primitive list reader 750 indicates that the processing of all the opaque primitives are completed and that the first transparent primitive is next to be processed. For subsequent primitives, which are transparent, loop controller 760 may instruct fragment shader 790 to render the pixels in the pixel mode—that is, one transparent primitive for a pixel at a time. Under this mode, if Z test unit 770 determines the transparent primitive being processed intersects with the pixel at a depth that is shallower than the value of depth stored in Z buffer 774 for the pixel, loop controller 760 may signal fragment shader 790 to immediately render the transparent primitive for that pixel. This process may be repeated until all pixels of the bin that intersect with the transparent primitive have been rendered, and lop controller 760 may signal primitive list reader 750 to receive or otherwise retrieve data associated with the next transparent primitive.

The following description of primitive list reader 750, loop controller 760, Z test unit 770, DPID buffer 772 and Z buffer 774 pertains to implementation of. example algorithm 600 with respect to Scenario 2. In this scenario, the opaque primitives are processed first as described above with respect to Scenario 1. However, before processing the transparent primitives, example scheme 700 needs to first sort the transparent primitives at each pixel according to the values of depth of the corresponding transparent primitives at the pixel.

For a bin being processed, e.g., one of bins 180(1,1)-180(Q,R) of frame 170, primitive list reader 750 may receive or otherwise retrieve data associated with a respective primitive list of one or more opaque primitives from bin memory 750. Primitive list reader 750 may start with a given pixel of the bin, and process each primitive in the primitive list in a sequential order for the pixel. After all the opaque primitives are processed for the given pixel, primitive list reader 750 may repeat the same for another pixel of the bin until the opaque primitives corresponding to all the pixels of the bin have been processed.

Upon completing the above process for opaque primitives for the pixels of the bin, primitive list reader 750 may signal loop controller 760 to inform loop controller 760 of the completion of processing of opaque primitives. Loop controller 760 may in turn signal waves 780 to receive or otherwise retrieve from DPID buffer 772 the PIDs of visible opaque primitives for rendering of the pixels of the bin in batch mode by fragment shader 790. At this stage the rendered primitives are opaque primitives.

After fragment shader 790 finishes the rendering of the opaque primitives, loop controller 760 may instruct primitive list reader 750 to further process transparent primitives for pixels of the bin. Similar to how the opaque primitives are processed, primitive list reader 750 may receive or otherwise retrieve data associated with a respective primitive list of one or more transparent primitives from bin memory 750. Primitive list reader 750 may start with a given pixel of the bin, and process each primitive in the primitive list in a sequential order for the pixel. After all the transparent primitives are processed for the given pixel, primitive list reader 750 may repeat the same for another pixel of the bin until the transparent primitives corresponding to all the pixels of the bin have been processed.

When processing the opaque primitives for a given pixel, primitive list reader 750 may receive or otherwise retrieve data associated with a first opaque primitive in sequence in the primitive list of one or more opaque primitives and determine whether or not the first opaque primitive intersects with the pixel. If it is determined that the first opaque primitive does not intersect with the pixel, primitive list reader 750 may disregard that opaque primitive. On the other hand, if it is determined that the first opaque primitive intersects with the pixel, primitive list reader 740 may forward data associated with the first opaque primitive to Z test unit 770. Primitive list reader 750 may then receive or otherwise retrieve data associated with a second opaque primitive in sequence in the primitive list of one or more opaque primitives, and determine whether or not the second opaque primitive intersects with the pixel, and either disregard the second opaque primitive or forward data associated with the second opaque primitive to Z test unit 770. Primitive list reader 750 may sequentially repeat the same for all the opaque primitives in the primitive list to conclude the processing of the opaque primitive list for each pixel of the bin.

Similarly, when processing the transparent primitives for a given pixel, primitive list reader 750 may receive or otherwise retrieve data associated with a first transparent primitive in sequence in the primitive list of one or more transparent primitives and determine whether or not the first transparent primitive intersects with the pixel. If it is determined that the first transparent primitive does not intersect with the pixel, primitive list reader 750 may disregard that transparent primitive. On the other hand, if it is determined that the first transparent primitive intersects with the pixel, primitive list reader 740 may forward data associated with the first transparent primitive to Z test unit 770. Primitive list reader 750 may then receive or otherwise retrieve data associated with a second transparent primitive in sequence in the primitive list of one or more transparent primitives, and determine whether or not the second transparent primitive intersects with the pixel, and either disregard the second transparent primitive or forward data associated with the second transparent primitive to Z test unit 770. Primitive list reader 750 may sequentially repeat the same for all the transparent primitives in the primitive list to conclude the processing of the transparent primitive list for each pixel of the bin.

When processing an opaque primitive for a given pixel, primitive list reader 750 may check the opaque primitive at the pixel to determine whether or not the opaque primitive intersects with, or corresponds to, the pixel. If it is determined that the opaque primitive does not intersect with the pixel, primitive list reader 750 may disregard that opaque primitive. If, however, it is determined that the opaque primitive does intersect with the pixel, primitive list reader 750 may immediately send data associated with the opaque primitive to Z test unit 770.

When processing transparent primitive for a given pixel, primitive list reader 750 may check the transparent primitive at the pixel to determine whether or not the transparent primitive intersects with, or corresponds to, the pixel. If it is determined that the transparent primitive does not intersect with the pixel, primitive list reader 750 may disregard that transparent primitive. If, however, it is determined that the transparent primitive does intersect with the pixel, primitive list reader 750 may, instead of sending data associated with the transparent primitive to Z test unit 770 immediately, primitive list reader 750 may keep track of the transparent primitive and its value of depth for that pixel. After all the transparent primitives that interest with, or correspond to, the pixel have been processed this way, primitive list reader 750 may sort the pixel-intersecting transparent primitives based on their respective values of depth at the pixel. Primitive list reader 750 may then send the data associated with the pixel-intersecting transparent primitives to Z test unit 770 one at a time, starting from the transparent primitive with the largest value of depth to the transparent primitive with the smallest value of depth. Accordingly, for those transparent primitives that are shallower than the visible opaque primitive at the pixel, loop controller 760 may instruct fragment shader to render the pixel with data associated with the transparent primitives that are shallower than the visible opaque primitive in an order from the deepest transparent primitive of the bunch to the shallowest transparent primitive of the bunch.

In the case that there is only one transparent primitive that intersects with the pixel, primitive list reader 750 may send data associated with the transparent primitive to Z test unit 770 immediately for Z test unit 770 to compare Z test on the transparent primitive as described above. If the transparent primitive is shallower than the visible opaque primitive at the pixel, loop controller 760 may instruct fragment shader 790 to render the pixel immediately with data associated with the transparent primitive.

In some embodiments, when forwarding data associated with a particular primitive to Z test unit 770, primitive list reader 750 may forward the following data: the coordinates of the pixel (e.g., X and Y coordinates of the pixel in the bin), the ID of the primitive (PID), the value of depth of the primitive at the pixel (Z value), and whether the primitive being processed is opaque or transparent (O/T flag).

In addition, primitive list reader 750 may report to loop controller 760 upon completing the above described processing for all the pixels of a bin.

Here, loop controller 760, Z test unit 770, DPID buffer 772 and Z buffer 774 may function the same in the implementation of example algorithm 400 with respect to Scenario 2 as described above.

The following description of primitive list reader 750, loop controller 760, Z test unit 770, DPID buffer 772 and Z buffer 774 pertains to implementation of example algorithm 500 with respect to Scenario 3.

Here, primitive list reader 750 may function the same as in the case of implementation of example algorithm 400 with respect to Scenario 2, except that primitive list reader 750 may process the primitives in order until the first transparent primitive is the next primitive to be processed. After completion of processing opaque primitives, primitive list reader 750 may conclude the completion by signaling loop controller 760. Loop controller 760 may in turn signal waves 780 to receive or otherwise retrieve from DPID buffer 772 the PIDs of visible opaque primitives for rendering of the pixels of the bin in batch mode by fragment shader 790. After the batch mode rendering is performed, primitive list reader 750 may continue to process the remaining primitives in the same way as described above regardless if the remaining primitives are actually transparent or opaque.

Loop controller 760, Z test unit 770, DPID buffer 772 and Z buffer 774 may function the same in the implementation of example algorithms 400 and 600 with respect to Scenario 2 as described above.

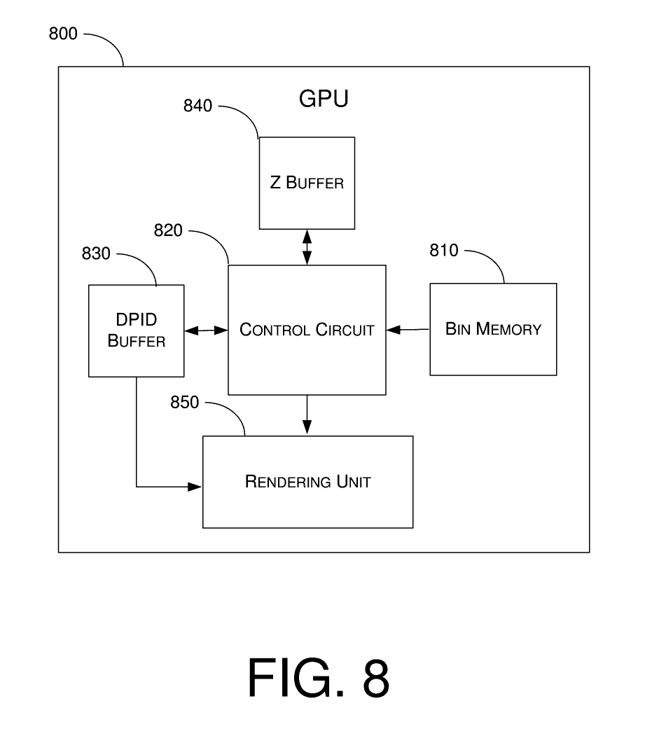

FIG. 8 is a block diagram of an example apparatus 800 in accordance with an embodiments of the present disclosure. Example apparatus 800 may perform various functions related to techniques, methods and systems described herein, including example algorithms 300, 400, 500 and 600 described above as well as example processes 900, 1000 and 1100 described below. Example apparatus 800 may be implemented as example device 110 in example framework 100. In some embodiments, example apparatus 800 may be a portable electronics apparatus such as, for example, a smartphone, a PDA, a camera, a camcorder or a computing device such as a tablet computer, a laptop computer, a notebook computer, a wearable device and the like, which is equipped with a graphics processing device. In such case, example apparatus 800 may include at least those components shown in FIG. 8, such as a bin memory 810, a control circuit 820, a DPID buffer 830, a Z buffer 840 and a rendering unit 850. Although bin memory 810, control circuit 820, DPID buffer 830, Z buffer 840 and rendering unit 850 are illustrated as discrete components separate from each other, in various embodiments of example apparatus 800 some or all of bin memory 810, control circuit 820, DPID buffer 830, Z buffer 840 and rendering unit 850 may be integral parts of a single integrated circuit (IC), chip or chipset.

In some other embodiments, example apparatus 800 may be, for example, a processor in the form of an IC, chip, chipset or an assembly of one or more chips and a PCB, which may be implementable in a portable electronics apparatus such as, for example, a smartphone, a PDA, a camera, a camcorder or a computing device such as a tablet computer, a laptop computer, a notebook computer, a wearable device and the like, which is equipped with a graphics processing device.

Bin memory 810 may be configured to store data related to a plurality of primitives associated with a bin, such as primitives 140(1)-140(M), primitives 150(1)-150(N) or primitives 160(1)-160(P) for any of the bins 180(1,1)-180(Q,R). In some embodiments bin memory 810 may be implemented in the form of a dynamic random access memory (DRAM).

DPID buffer 830 may be configured to record or otherwise store identifications of visible primitives for a plurality of pixels of the bin. DPID buffer 830 may have a size the same as that of the bin.

Z buffer 840 may be configured to record or otherwise store values of depths of the visible primitives for the plurality of pixels of the bin. Z buffer 840 may have a size the same as that of the bin. In some embodiments bin Z buffer 840 may be implemented in the form of a DRAM.

In some embodiments, DPID buffer 830 and Z buffer 840 may be integral parts of a same buffer. For example, a single buffer may be configured to function as both the DPID buffer 830 and Z buffer 840 such that the single buffer may record or otherwise store, for each pixel of a bin, the identifications of the visible primitive for that pixel as well as the value of depth of the visible primitive at that pixel. That is, for each pixel, the buffer may have a field that records or otherwise stores the identifications of the visible primitive for that pixel and another field that records or otherwise stores the value of depth of the visible primitive at that pixel.

Rendering unit 850 may be configured to receive the identifications of the visible primitives from DPID buffer 830, and receive other data associated with the visible primitives from control circuit 820. Rendering unit 850 may also be configured to render the plurality of pixels of the bin in batches based at least in part on data related to the visible primitives such that a batch of multiple pixels of the plurality of pixels of the bin are rendered at a time.

Control circuit 820 may be coupled to DPID buffer 830, Z buffer 840, bin memory 810 and rendering unit 850. Control circuit 820 may be configured to store identifications of a set of visible primitives among one or more primitives of the plurality of primitives associated with the bin in DPID buffer 830. Each visible primitive may correspond to a respective pixel of a plurality of pixels of the bin such that data related to the set of visible primitives is used in rendering the plurality of pixels of the bin. Each pixel of the bin may correspond to one or more primitives of the plurality of primitives. At each pixel of the bin, a depth of the corresponding visible primitive relative to an image plane may be less or not greater than a depth of each of one or more other primitives of the plurality of primitives relative to the image plane.

Control circuit 820 may be also configured to store values of the depths of the set of visible primitives corresponding to the plurality of pixels of the bin in Z buffer 840. Control circuit 820 may be further configured to dispatch or otherwise provide at least the identifications of the set of visible primitives in batches subsequent to storing the identifications of the set of visible primitives in DPID buffer 830.

In one aspect, for each pixel of a plurality of pixels of a bin, control circuit 820 may determine a primitive of a plurality of primitives associated with a bin as a respective visible primitive at the pixel. Each pixel of the bin may correspond to one or more primitives of the plurality of primitives. A depth of the respective visible primitive relative to an image plane at each pixel may be less or not greater than a depth of each of other primitives of the plurality of primitives relative to the image plane at the pixel. For each pixel of the plurality of pixels of the bin, control circuit 820 may store an identification of the respective visible primitive in DPID buffer 830 such that identifications of a set of visible primitives for the plurality of pixels of the bin are stored in DP ID buffer 830. Control circuit 820 may also dispatch or otherwise provide at least the identifications of the set of visible primitives for rendering of the plurality of pixels of the bin.

In determining a primitive of the plurality of primitives associated with the bin as the respective visible primitive at the pixel for each pixel of the bin, control circuit 820 may, for each pixel of the bin, in an event that the pixel corresponds to one primitive of the plurality of primitives, store an identification of the one primitive in DPID buffer 830 as the visible primitive corresponding to the pixel. For each pixel of the bin, in an event that the pixel corresponds to multiple primitives of the plurality of primitives, control circuit 820 may compare the depths of the multiple primitives at the pixel to determine a primitive of the multiple primitives as having a depth less than a depth of each of remaining one or more other primitives of the multiple primitives relative to the image plane at the pixel. For each pixel of the bin, control circuit 820 may store an identification of the determined primitive in DPID buffer 830 as the visible primitive corresponding to the pixel.

In at least some embodiments, the set of visible primitives may include one or more opaque primitives among the plurality of primitives.

In at least some embodiments, the plurality of primitives may include the one or more opaque primitives and one or more transparent primitives. Control circuit 820 may be configured to receive, e.g., form bin memory 810, data related to the one or more transparent primitives. Each of the one or more transparent primitives may correspond to one or more pixels of the bin. For each transparent primitive of the one or more transparent primitive, control circuit 820 may determine whether a depth of the transparent primitive is less than the depth of the visible primitive relative to the image plane at a corresponding pixel of the plurality of pixels of the bin. For each transparent primitive of the one or more transparent primitive, control circuit 820 may also, in response to determining that the depth of the transparent primitive is less than the depth of the visible primitive relative to the image plane at the corresponding pixel, dispatch or otherwise provide at least an identification of the transparent primitive for rendering of the transparent primitive at the corresponding pixel, e.g., by rendering unit 850.

Control circuit 820 may be also configured to receive data, e.g., from bin memory 810, related to an opaque primitive after receiving data related to at least one transparent primitive of the one or more transparent primitives. The opaque primitive may correspond to one or more pixels of the bin. For each pixel of the bin that corresponds to the opaque primitive, control circuit 820 may determine whether a depth of the opaque primitive is less than the depth of the corresponding visible primitive relative to the image plane at the pixel. For each pixel of the bin that corresponds to the opaque primitive, control circuit 820 may also, in response to determining that the depth of the opaque primitive is less than the depth of the corresponding visible primitive relative to the image plane at the pixel, dispatch or otherwise provide at least an identification of the opaque primitive for rendering of the opaque primitive at the pixel.

Control circuit 820 may be also configured to, for each pixel of the bin that corresponds to at least one transparent primitive of the one or more transparent primitives, update a field associated with the pixel in DPID buffer 830 when the control circuit first determines that one of the one or more transparent primitives corresponds to the pixel.

In at least some embodiments, the plurality of primitives may include the one or more opaque primitives and one or more transparent primitives. Control circuit 820 may be configured to receive, e.g., from bin memory 810, data related to the one or more transparent primitives. Each of the one or more transparent primitives may correspond to one or more pixels of the bin. For each pixel of the bin that corresponds to at least one transparent primitive of the one or more transparent primitives, control circuit 820 may determine whether a depth of each transparent primitive of the at least one transparent primitive is less than the depth of the visible primitive relative to the image plane at the pixel. For each pixel of the bin that corresponds to at least one transparent primitive of the one or more transparent primitives, control circuit 820 may also, in an event that the depth of one transparent primitive of the at least one transparent primitive is less than the depth of the visible primitive relative to the image plane at the pixel, dispatch or otherwise provide at least an identification of the one transparent primitive for rendering of the one transparent primitive at the pixel. For each pixel of the bin that corresponds to at least one transparent primitive of the one or more transparent primitives, control circuit 820 may also, in an event that the depths of multiple transparent primitives of the at least one transparent primitive are less than the depth of the visible primitive relative to the image plane at the pixel, dispatch or otherwise provide at least identifications of the multiple transparent primitives in a descending order with respect to the depths of the multiple transparent primitives such that the pixel is rendered first with data associated with a first transparent primitive of the multiple transparent primitives and then with data associated with a second transparent primitive of the multiple transparent primitives. A depth of the first transparent primitive may be greater than a depth of the second transparent primitive but not greater than the depth of the visible primitive relative to the image plane at the pixel.

Control circuit 820 may be also configured to store values of the depths of the set of visible primitives corresponding to the plurality of pixels of the bin in Z buffer 840.

In storing the values of the depths of the set of visible primitives corresponding to the plurality of pixels of the bin in Z buffer 840, control circuit 820 may, for each pixel of the bin, in an event that the pixel corresponds to one primitive of the plurality of primitives, store a value of the depth of the one primitive in Z buffer 840 as the visible primitive corresponding to the pixel. For each pixel of the bin, in an event that the pixel corresponds to multiple primitives of the plurality of primitives, control circuit 820 may compare the depths of the multiple primitives at the pixel to determine a primitive of the multiple primitives as having a depth less than a depth of each of remaining one or more other primitives of the multiple primitives relative to the image plane at the pixel. For each pixel of the bin, in an event that the pixel corresponds to multiple primitives of the plurality of primitives, control circuit 820 may also store a value of the depth of the determined primitive in Z buffer 840 as the visible primitive corresponding to the pixel.

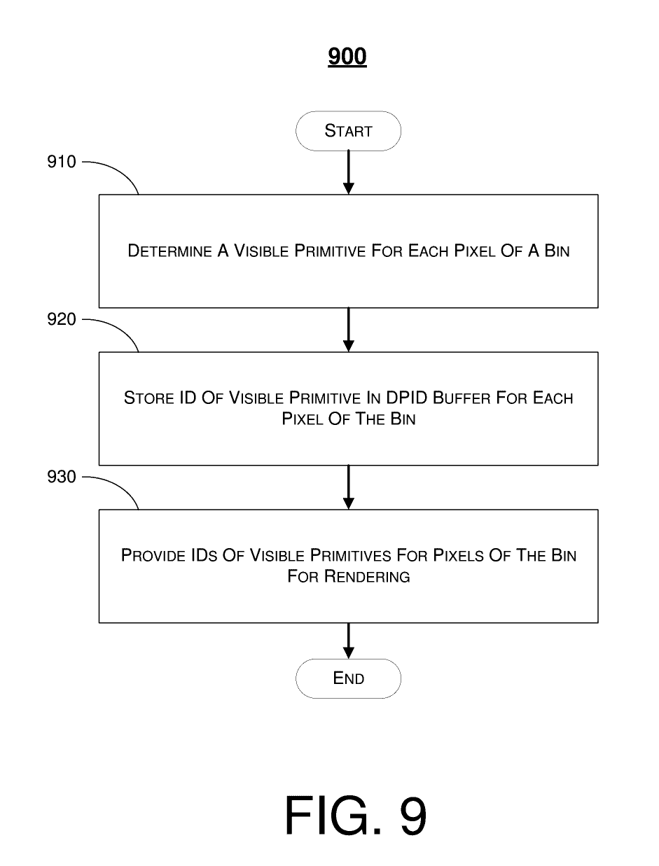

FIG. 9 is a flowchart of an example process 900 of cost-effective in-bin primitive pre-ordering in accordance with an embodiment of the present disclosure. Example process 900 may represent one aspect of implementing features of example algorithms 300, 400, 500 and 600. Example process 900 may include one or more operations, actions, or functions as illustrated by one or more of blocks 910, 920 and 930. Although illustrated as discrete blocks, various blocks may be divided into additional blocks, combined into fewer blocks, or eliminated, depending on the desired implementation. Example process 900 may be implemented by control circuit 120 of example device 110, one or more components of example scheme 700 or control circuit 820 of example apparatus 800. For illustrative purposes, the operations described below are performed by control circuit 820 of example apparatus 800. Example process 900 may begin at block 910.

Block 910 (Determine A Visible Primitive For Each Pixel Of A Bin) may refer to control circuit 820 determining, for each pixel of a plurality of pixels of a bin, a primitive of a plurality of primitives associated with a bin as a respective visible primitive at the pixel. Each pixel of the bin may correspond to one or more primitives of the plurality of primitives. A depth of the respective visible primitive relative to an image plane at each pixel may be less or not greater than a depth of each of other primitives of the plurality of primitives relative to the image plane at the pixel. Block 910 may be followed by block 920.

Block 920 (Store ID Of Visible Primitive In DPID Buffer For Each Pixel Of The Bin) may refer to control circuit 820 storing, for each pixel of the plurality of pixels of the bin, an identification of the respective visible primitive in a first buffer, e.g., DPID buffer 830, such that identifications of a set of visible primitives for the plurality of pixels of the bin are stored in the first buffer. Block 920 may be followed by block 930.

Block 930 (Provide IDs Of Visible Primitive For Pixels Of The Bin For Rendering) may refer to control circuit 820 providing at least the identifications of the set of visible primitives for rendering of the plurality of pixels of the bin.

In at least some embodiments, in determining a primitive of the plurality of primitives associated with the bin as the respective visible primitive at the pixel for each pixel of the bin, example process 900 may involve control circuit 820 performing operations including, for each pixel of the bin, in an event that the pixel corresponds to one primitive of the plurality of primitives, storing an identification of the one primitive in the first buffer as the visible primitive corresponding to the pixel. Example process 900 may also involve control circuit 820 performing operations, for each pixel of the bin, in an event that the pixel corresponds to multiple primitives of the plurality of primitives. Accordingly, control circuit 820 may compare the depths of the multiple primitives at the pixel to determine a primitive of the multiple primitives as having a depth less than a depth of each of remaining one or more other primitives of the multiple primitives relative to the image plane at the pixel. Control circuit 820 may also store an identification of the determined primitive in the first buffer as the visible primitive corresponding to the pixel.

In at least some embodiments, the set of visible primitives may include one or more opaque primitives among the plurality of primitives.

In at least some embodiments, the plurality of primitives may include the one or more opaque primitives and one or more transparent primitives. Example process 900 may involve control circuit 820 receiving data related to the one or more transparent primitives, each of the one or more transparent primitives corresponding to one or more pixels of the bin. For each transparent primitive of the one or more transparent primitive, control circuit 820 may determine whether a depth of the transparent primitive is less than the depth of the visible primitive relative to the image plane at a corresponding pixel of the plurality of pixels of the bin. For each transparent primitive of the one or more transparent primitive, control circuit 820 may also, in response to determining that the depth of the transparent primitive is less than the depth of the visible primitive relative to the image plane at the corresponding pixel, dispatch or otherwise provide at least an identification of the transparent primitive for rendering of the transparent primitive at the corresponding pixel.

In at least some embodiments, example process 900 may also involve control circuit 820 receiving data related to an opaque primitive after receiving data related to at least one transparent primitive of the one or more transparent primitives, the opaque primitive corresponding to one or more pixels of the bin. For each pixel of the bin that corresponds to the opaque primitive, control circuit 820 may determine whether a depth of the opaque primitive is less than the depth of the corresponding visible primitive relative to the image plane at the pixel. For each pixel of the bin that corresponds to the opaque primitive, control circuit 820 may, in response to determining that the depth of the opaque primitive is less than the depth of the corresponding visible primitive relative to the image plane at the pixel, dispatch or otherwise provide at least an identification of the opaque primitive for rendering of the opaque primitive at the pixel.

In at least some embodiments, for each pixel of the bin that corresponds to at least one transparent primitive of the one or more transparent primitives, example process 900 may involve control circuit 820 updating a field associated with the pixel in the first buffer when the control circuit first determines that one of the one or more transparent primitives corresponds to the pixel.

In at least some embodiments, the plurality of primitives may include the one or more opaque primitives and one or more transparent primitives. Example process 900 may involve control circuit 820 receiving data related to the one or more transparent primitives, each of the one or more transparent primitives corresponding to one or more pixels of the bin. For each pixel of the bin that corresponds to at least one transparent primitive of the one or more transparent primitives, control circuit 820 may determine whether a depth of each transparent primitive of the at least one transparent primitive is less than the depth of the visible primitive relative to the image plane at the pixel. For each pixel of the bin that corresponds to at least one transparent primitive of the one or more transparent primitives, control circuit 820 may, in an event that the depth of one transparent primitive of the at least one transparent primitive is less than the depth of the visible primitive relative to the image plane at the pixel, dispatch or otherwise provide at least an identification of the one transparent primitive for rendering of the one transparent primitive at the pixel. For each pixel of the bin that corresponds to at least one transparent primitive of the one or more transparent primitives, control circuit 820 may, in an event that the depths of multiple transparent primitives of the at least one transparent primitive are less than the depth of the visible primitive relative to the image plane at the pixel, dispatch or otherwise provide at least identifications of the multiple transparent primitives in a descending order with respect to the depths of the multiple transparent primitives such that the pixel is rendered first with data associated with a first transparent primitive of the multiple transparent primitives and then with data associated with a second transparent primitive of the multiple transparent primitives. A depth of the first transparent primitive may be greater than a depth of the second transparent primitive but not greater than the depth of the visible primitive relative to the image plane at the pixel.

In at least some embodiments, example process 900 may further involve control circuit 820 storing values of the depths of the set of visible primitives corresponding to the plurality of pixels of the bin in a second buffer, e.g., Z buffer 840.

In at least some embodiments, in storing the values of the depths of the set of visible primitives corresponding to the plurality of pixels of the bin in the second buffer, example process 900 may involve control circuit 820 performing operations including, for each pixel of the bin, in an event that the pixel corresponds to one primitive of the plurality of primitives, storing a value of the depth of the one primitive in the second buffer as the visible primitive corresponding to the pixel. For each pixel of the bin, in an event that the pixel corresponds to multiple primitives of the plurality of primitives, control circuit 820 may compare the depths of the multiple primitives at the pixel to determine a primitive of the multiple primitives as having a depth less than a depth of each of remaining one or more other primitives of the multiple primitives relative to the image plane at the pixel. For each pixel of the bin, in an event that the pixel corresponds to multiple primitives of the plurality of primitives, control circuit 820 may store a value of the depth of the determined primitive in the second buffer as the visible primitive corresponding to the pixel.

In at least some embodiments, example process 900 may also involve a bin memory, e.g., bin memory 810, storing data related to the plurality of primitives associated with the bin. Example process 900 may further involve a rendering unit, e.g., rendering unit 850, performing operations including: receiving the identifications of the visible primitives from the control circuit; and rendering the plurality of pixels of the bin in batches based at least in part on data related to the visible primitives such that a batch of multiple pixels of the plurality of pixels of the bin are rendered at a time.

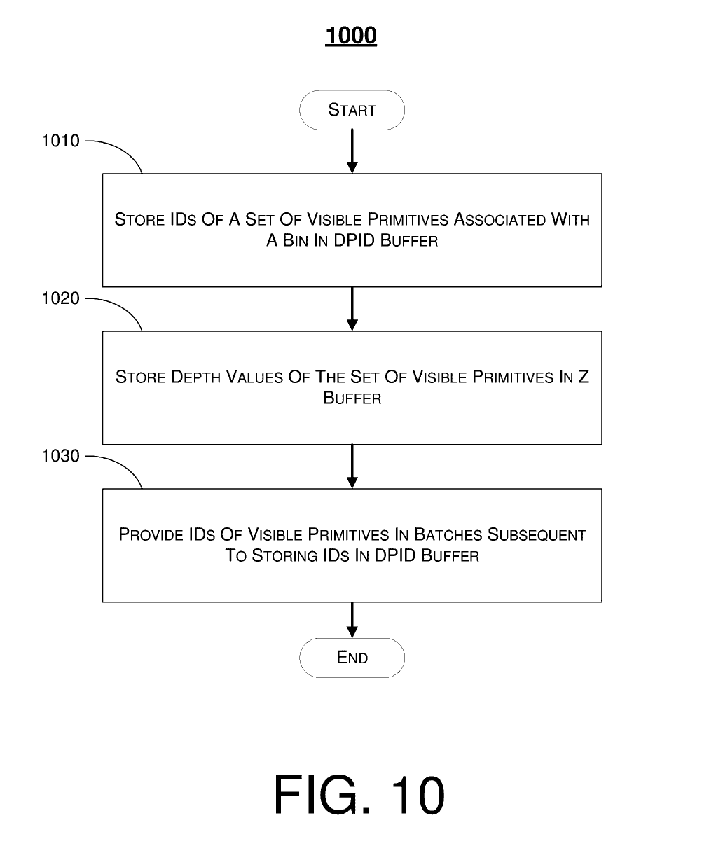

FIG. 10 is a flowchart of another example process 1000 of cost-effective in-bin primitive pre-ordering in accordance with an embodiment of the present disclosure. Example process 1000 may represent another aspect of implementing features of example algorithms 300, 400, 500 and 600. Example process 1000 may include one or more operations, actions, or functions as illustrated by one or more of blocks 1010, 1020 and 1030. Although illustrated as discrete blocks, various blocks may be divided into additional blocks, combined into fewer blocks, or eliminated, depending on the desired implementation. Example process 1000 may be implemented by control circuit 120 of example device 110, one or more components of example scheme 700 or control circuit 820 of example apparatus 800. For illustrative purposes, the operations described below are performed by control circuit 820 of example apparatus 800. Example process 1000 may begin at block 1010.

Block 1010 (Store IDs Of A Set Of Visible Primitives Associated With A Bin In DPID Buffer) may refer to control circuit 820 storing identifications of a set of visible primitives among one or more primitives of a plurality of primitives associated with a bin in a first buffer, e.g., DPID buffer 830. Each visible primitive may correspond to a respective pixel of a plurality of pixels of the bin such that data related to the set of visible primitives is used in rendering the plurality of pixels of the bin. Each pixel of the bin may correspond to one or more primitives of the plurality of primitives. At each pixel of the bin, a depth of the corresponding visible primitive relative to an image plane may be less or not greater than a depth of each of one or more other primitives of the plurality of primitives relative to the image plane. Block 1010 may be followed by block 1020.

Block 1020 (Store Values of depth Of The Set Of Visible Primitives In Z Buffer) may refer to control circuit 820 storing values of the depths of the set of visible primitives corresponding to the plurality of pixels of the bin in a second buffer, e.g., Z buffer 840. Block 1020 may be followed by block 1030.

Block 1030 (Provide IDs Of Visible Primitives In Batches Subsequent To Storing IDs In DP ID Buffer) may refer to control circuit 820 providing at least the identifications of the set of visible primitives in batches subsequent to storing the identifications of the set of visible primitives in the first buffer.

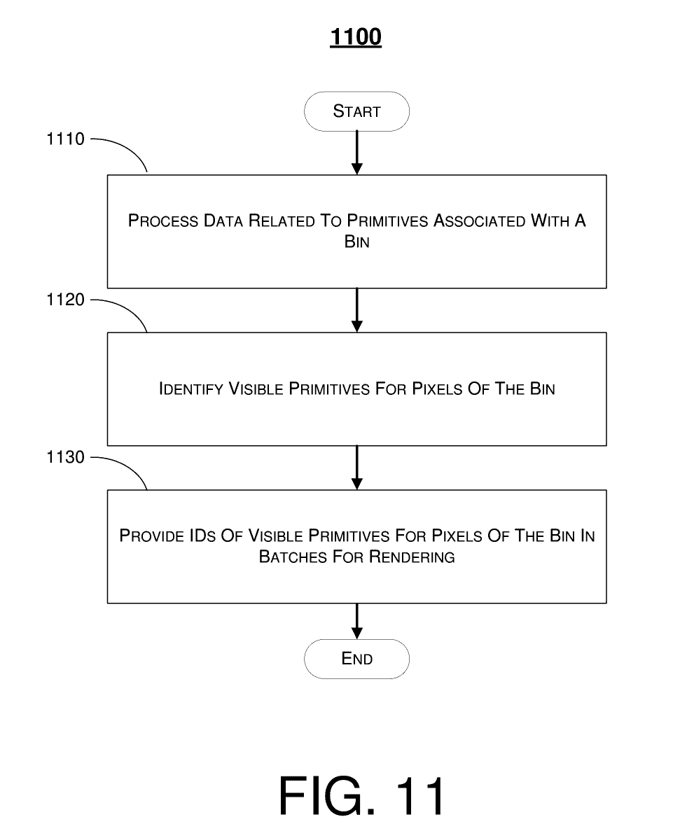

FIG. 11 is a flowchart of yet another example process 1100 of cost-effective in-bin primitive pre-ordering in accordance with an embodiment of the present disclosure. Example process 1100 may represent yet another aspect of implementing features of example algorithms 300, 400, 500 and 600. Example process 1100 may include one or more operations, actions, or functions as illustrated by one or more of blocks 1110, 1120 and 1130. Although illustrated as discrete blocks, various blocks may be divided into additional blocks, combined into fewer blocks, or eliminated, depending on the desired implementation. Example process 1100 may be implemented by control circuit 120 of example device 110, one or more components of example scheme 700 or control circuit 820 of example apparatus 800. For illustrative purposes, the operations described below are performed by control circuit 820 of example apparatus 800. Example process 1100 may begin at block 1110.

Block 1110 (Process Data Related To Primitives Associated With A Bin) may refer to control circuit 820 processing data related to a plurality of primitives associated with a bin. The plurality of primitives may include one or more opaque primitives. Block 1110 may be followed by block 1120.

Block 1120 (Identify Visible Primitives For Pixels Of The Bin) may refer to control circuit 820 identifying one or more primitives of the plurality of primitives as a set of visible primitives for a plurality of pixels of the bin. Each visible primitive of the set of visible primitives may correspond to a respective pixel of the plurality of pixels of the bin. At each pixel of the bin, a depth of the visible primitive relative to an image plane may be less or not greater than a depth of each of one or more other primitives of the plurality of primitives relative to the image plane. Block 1120 may be followed by block 1130.

Block 1130 (Provide IDs Of Visible Primitives For Pixels Of The Bin In Batches For Rendering) may refer to control circuit 820 providing at least identifications of the set of visible primitives in batches for rendering of the plurality of pixels of the bin such that a batch of multiple pixels of the plurality of pixels of the bin are rendered at a time.

In at least some embodiments, in identifying one or more primitives of the plurality of primitives as the set of visible primitives for the plurality of pixels of the bin, example process 1100 may involve control circuit 820 storing, for each pixel of the bin, an identification of a first primitive of at least one primitive of the plurality of primitives corresponding to the pixel in a first buffer, e.g., DPID buffer 830, to indicate the first primitive as the visible primitive for the pixel. Data associated with the first primitive may be received before data associated with one or more other primitives of the at least one primitive is received in a sequential order. Example process 1100 may also involve control circuit 820 determining, for each pixel of the bin, whether a depth of the one or more other primitives of the at least one primitive is less than a depth of the first primitive relative to the image plane at the pixel. Example process 1100 may also involve control circuit 820 storing, in response to determining that a depth of a second primitive of the one or more other primitives of the at least one primitive is less than the depth of the first primitive, an identification of the second primitive in the first buffer to replace the identification of the first primitive for the pixel to indicate the second primitive as the visible primitive for the pixel.

In at least some embodiments, example process 1100 may further involve control circuit 820 storing values of the depths of the set of visible primitives corresponding to the plurality of pixels of the bin in a second buffer.

In at least some embodiments, in storing the values of the depths of the set of visible primitives corresponding to the plurality of pixels of the bin in the second buffer, example process 1100 may involve control circuit 830 storing, for each pixel of the bin, a value of a depth of a first primitive of at least one primitive of the plurality of primitives corresponding to the pixel in the second buffer. Data associated with the first primitive may be received before data associated with one or more other primitives of the at least one primitive is received in a sequential order. Example process 1100 may also involve control circuit 820 determining, for each pixel of the bin, whether a depth of the one or more other primitives of the at least one primitive is less than a depth of the first primitive relative to the image plane at the pixel. Example process 1100 may also involve control circuit 820 storing, in response to determining that a depth of a second primitive of the one or more other primitives of the at least one primitive is less than the depth of the first primitive, a value of a depth of the second primitive in the second buffer to replace the value of the depth of the first primitive for the pixel.

In at least some embodiments, the plurality of primitives may include the one or more opaque primitives and one or more transparent primitives.

In at least some embodiments, example process 1100 may further involve control circuit 820 receiving data related to the one or more transparent primitives. Each of the one or more transparent primitives may correspond to one or more pixels of the bin. For each transparent primitive of the one or more transparent primitive, control circuit 820 may determine whether a depth of the transparent primitive is less than the depth of the visible primitive relative to the image plane at a corresponding pixel of the plurality of pixels of the bin. For each transparent primitive of the one or more transparent primitive, control circuit 820 may, in response to determining that the depth of the transparent primitive is less than the depth of the visible primitive relative to the image plane at the corresponding pixel, dispatch or otherwise provide at least an identification of the transparent primitive for rendering of the transparent primitive at the corresponding pixel.

In at least some embodiments, example process 1100 may further involve control circuit 820 receiving data related to an opaque primitive after receiving data related to at least one transparent primitive of the one or more transparent primitives. The opaque primitive may correspond to one or more pixels of the bin. For each pixel of the bin that corresponds to the opaque primitive, control circuit 820 may determine whether a depth of the opaque primitive is less than the depth of the corresponding visible primitive relative to the image plane at the pixel. For each pixel of the bin that corresponds to the opaque primitive, control circuit 820 may, in response to determining that the depth of the opaque primitive is less than the depth of the corresponding visible primitive relative to the image plane at the pixel, dispatch or otherwise provide at least an identification of the opaque primitive for rendering of the opaque primitive at the pixel.

In at least some embodiments, example process 1100 may further involve control circuit 820 updating, for each pixel of the bin that corresponds to at least one transparent primitive of the one or more transparent primitives, a field associated with the pixel in the first buffer when the control circuit first determines that one of the one or more transparent primitives corresponds to the pixel.

In at least some embodiments, example process 1100 may further involve control circuit 820 receiving data related to the one or more transparent primitives, each of the one or more transparent primitives corresponding to one or more pixels of the bin. For each pixel of the bin that corresponds to at least one transparent primitive of the one or more transparent primitives, control circuit 820 may determine whether a depth of each transparent primitive of the at least one transparent primitive is less than the depth of the visible primitive relative to the image plane at the pixel. For each pixel of the bin that corresponds to at least one transparent primitive of the one or more transparent primitives, control circuit 820 may, in an event that the depth of one transparent primitive of the at least one transparent primitive is less than the depth of the visible primitive relative to the image plane at the pixel, dispatch or otherwise provide at least an identification of the one transparent primitive for rendering of the one transparent primitive at the pixel. For each pixel of the bin that corresponds to at least one transparent primitive of the one or more transparent primitives, control circuit 820 may, in an event that the depths of multiple transparent primitives of the at least one transparent primitive are less than the depth of the visible primitive relative to the image plane at the pixel, dispatch or otherwise provide at least identifications of the multiple transparent primitives in a descending order with respect to the depths of the multiple transparent primitives such that the pixel is rendered first with data associated with a first transparent primitive of the multiple transparent primitives and then with data associated with a second transparent primitive of the multiple transparent primitives. A depth of the first transparent primitive may be greater than a depth of the second transparent primitive but not greater than the depth of the visible primitive relative to the image plane at the pixel.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “ a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A device implementable in a graphics processing unit (GPU), comprising:
a first buffer configured to store an identification of a respective visible primitive for each pixel of a plurality of pixels of a bin; and
a control circuit coupled to the first buffer, the control circuit configured to:
determine, for each pixel of the bin, a particular primitive of a plurality of primitives associated with the bin as the respective visible primitive at the pixel; and
store, in the first buffer, the identification of the respective visible primitive for each pixel of the bin before the plurality of pixels of the bin are rendered in batches.

2. The device of claim 1, each pixel of the bin corresponds to one or more primitives of the plurality of primitives, and wherein a depth of the respective visible primitive relative to an image plane at each pixel is less or not greater than a depth of each of other primitives of the plurality of primitives relative to the image plane at the pixel.

3. The device of claim 1, wherein in determining, for each pixel of the bin, a particular primitive of a plurality of primitives associated with the bin as the respective visible primitive at the pixel, the control circuit is configured to perform operations comprising:
for each pixel of the bin, in an event that the pixel corresponds to one primitive of the plurality of primitives, storing an identification of the one primitive in the first buffer as the visible primitive corresponding to the pixel; and
for each pixel of the bin, in an event that the pixel corresponds to multiple primitives of the plurality of primitives:
comparing the depths of the multiple primitives at the pixel to determine a primitive of the multiple primitives as having a depth less than a depth of each of remaining one or more other primitives of the multiple primitives relative to the image plane at the pixel; and
storing an identification of the determined primitive in the first buffer as the visible primitive corresponding to the pixel.

4. The device of claim 1, wherein the plurality of primitives comprises one or more opaque primitives and one or more transparent primitives, and wherein the control circuit is further configured to perform operations comprising:
receiving data related to the one or more transparent primitives, each of the one or more transparent primitives corresponding to one or more pixels of the bin; and
for each transparent primitive of the one or more transparent primitive:
determining whether a depth of the transparent primitive is less than the depth of the visible primitive relative to the image plane at a corresponding pixel of the plurality of pixels of the bin; and
in response to determining that the depth of the transparent primitive is less than the depth of the visible primitive relative to the image plane at the corresponding pixel, providing at least an identification of the transparent primitive for rendering of the transparent primitive at the corresponding pixel.

5. The device of claim 4, wherein the control circuit is further configured to perform operations comprising:
receiving data related to an opaque primitive after receiving data related to at least one transparent primitive of the one or more transparent primitives, the opaque primitive corresponding to one or more pixels of the bin; and
for each pixel of the bin that corresponds to the opaque primitive:
determining whether a depth of the opaque primitive is less than the depth of the corresponding visible primitive relative to the image plane at the pixel; and
in response to determining that the depth of the opaque primitive is less than the depth of the corresponding visible primitive relative to the image plane at the pixel, providing at least an identification of the opaque primitive for rendering of the opaque primitive at the pixel.

6. The device of claim 4, wherein the control circuit is further configured to perform operations comprising:
for each pixel of the bin that corresponds to at least one transparent primitive of the one or more transparent primitives, updating a field associated with the pixel in the first buffer when the control circuit first determines that one of the one or more transparent primitives corresponds to the pixel.

7. The device of claim 1, wherein the plurality of primitives comprise one or more opaque primitives and one or more transparent primitives, and wherein the control circuit is further configured to perform operations comprising:
receiving data related to the one or more transparent primitives, each of the one or more transparent primitives corresponding to one or more pixels of the bin; and
for each pixel of the bin that corresponds to at least one transparent primitive of the one or more transparent primitives:
determining whether a depth of each transparent primitive of the at least one transparent primitive is less than the depth of the visible primitive relative to the image plane at the pixel;
in an event that the depth of one transparent primitive of the at least one transparent primitive is less than the depth of the visible primitive relative to the image plane at the pixel, providing at least an identification of the one transparent primitive for rendering of the one transparent primitive at the pixel; and
in an event that the depths of multiple transparent primitives of the at least one transparent primitive are less than the depth of the visible primitive relative to the image plane at the pixel, providing at least identifications of the multiple transparent primitives in a descending order with respect to the depths of the multiple transparent primitives such that the pixel is rendered first with data associated with a first transparent primitive of the multiple transparent primitives and then with data associated with a second transparent primitive of the multiple transparent primitives, wherein a depth of the first transparent primitive is greater than a depth of the second transparent primitive but not greater than the depth of the visible primitive relative to the image plane at the pixel.

8. The device of claim 1, further comprising:
a second buffer coupled to the control circuit, wherein:
the control circuit is configured to store values of depth of a set of visible primitives corresponding to the plurality of pixels of the bin in the second buffer.

9. The device of claim 8, wherein, in storing the values of the depths of the set of visible primitives corresponding to the plurality of pixels of the bin in the second buffer, the control circuit is configured to perform operations comprising:
for each pixel of the bin, in an event that the pixel corresponds to one primitive of the plurality of primitives, storing a value of the depth of the one primitive in the second buffer as the visible primitive corresponding to the pixel; and
for each pixel of the bin, in an event that the pixel corresponds to multiple primitives of the plurality of primitives:
comparing the depths of the multiple primitives at the pixel to determine a primitive of the multiple primitives as having a depth less than a depth of each of remaining one or more other primitives of the multiple primitives relative to the image plane at the pixel; and
storing a value of the depth of the determined primitive in the second buffer as the visible primitive corresponding to the pixel.

10. The device of claim 1, further comprising:
a bin memory configured to store data related to the plurality of primitives associated with the bin; and
a rendering unit configured to perform operations comprising:
receiving the identifications of the visible primitives from the control circuit; and
rendering the plurality of pixels of the bin in batches based at least in part on data related to the visible primitives such that a batch of multiple pixels of the plurality of pixels of the bin are rendered at a time.

11. A method implementable in a graphics processing unit (GPU), comprising:
processing, by a control circuit, data related to a plurality of primitives associated with a bin, the plurality of primitives comprising one or more opaque primitives;
identifying, by the control circuit, one or more primitives of the plurality of primitives as a set of visible primitives for a plurality of pixels of the bin, wherein:
each visible primitive of the set of visible primitives corresponds to a respective pixel of the plurality of pixels of the bin; and
at each pixel of the bin, a depth of the visible primitive relative to an image plane is less or not greater than a depth of each of one or more other primitives of the plurality of primitives relative to the image plane; and
providing, by the control circuit, at least identifications of the set of visible primitives in batches for rendering of the plurality of pixels of the bin such that a batch of multiple pixels of the plurality of pixels of the bin are rendered at a time.

12. The method of claim 11, wherein identifying one or more primitives of the plurality of primitives as the set of visible primitives for the plurality of pixels of the bin comprises:
for each pixel of the bin:
storing an identification of a first primitive of at least one primitive of the plurality of primitives corresponding to the pixel in a first buffer to indicate the first primitive as the visible primitive for the pixel, wherein data associated with the first primitive is received before data associated with one or more other primitives of the at least one primitive is received in a sequential order;
determining whether a depth of the one or more other primitives of the at least one primitive is less than a depth of the first primitive relative to the image plane at the pixel; and
in response to determining that a depth of a second primitive of the one or more other primitives of the at least one primitive is less than the depth of the first primitive, storing an identification of the second primitive in the first buffer to replace the identification of the first primitive for the pixel to indicate the second primitive as the visible primitive for the pixel.

13. The method of claim 11, further comprising:
storing values of the depths of the set of visible primitives corresponding to the plurality of pixels of the bin in a second buffer.

14. The method of claim 13, wherein storing the values of the depths of the set of visible primitives corresponding to the plurality of pixels of the bin in the second buffer comprises:
for each pixel of the bin:
storing a value of a depth of a first primitive of at least one primitive of the plurality of primitives corresponding to the pixel in the second buffer, wherein data associated with the first primitive is received before data associated with one or more other primitives of the at least one primitive is received in a sequential order;
determining whether a depth of the one or more other primitives of the at least one primitive is less than a depth of the first primitive relative to the image plane at the pixel; and
in response to determining that a depth of a second primitive of the one or more other primitives of the at least one primitive is less than the depth of the first primitive, storing a value of a depth of the second primitive in the second buffer to replace the value of the depth of the first primitive for the pixel.

15. The method of claim 11, wherein the plurality of primitives comprises the one or more opaque primitives and one or more transparent primitives.

16. The method of claim 15, further comprising:
receiving data related to the one or more transparent primitives, each of the one or more transparent primitives corresponding to one or more pixels of the bin; and
for each transparent primitive of the one or more transparent primitive:
determining whether a depth of the transparent primitive is less than the depth of the visible primitive relative to the image plane at a corresponding pixel of the plurality of pixels of the bin; and
in response to determining that the depth of the transparent primitive is less than the depth of the visible primitive relative to the image plane at the corresponding pixel, providing at least an identification of the transparent primitive for rendering of the transparent primitive at the corresponding pixel.

17. The method of claim 16, further comprising:
receiving data related to an opaque primitive after receiving data related to at least one transparent primitive of the one or more transparent primitives, the opaque primitive corresponding to one or more pixels of the bin; and
for each pixel of the bin that corresponds to the opaque primitive:
determining whether a depth of the opaque primitive is less than the depth of the corresponding visible primitive relative to the image plane at the pixel; and
in response to determining that the depth of the opaque primitive is less than the depth of the corresponding visible primitive relative to the image plane at the pixel, providing at least an identification of the opaque primitive for rendering of the opaque primitive at the pixel.

18. The method of claim 16, further comprising:
for each pixel of the bin that corresponds to at least one transparent primitive of the one or more transparent primitives, updating a field associated with the pixel in the first buffer when the control circuit first determines that one of the one or more transparent primitives corresponds to the pixel.

19. The method of claim 15, further comprising:
receiving data related to the one or more transparent primitives, each of the one or more transparent primitives corresponding to one or more pixels of the bin; and
for each pixel of the bin that corresponds to at least one transparent primitive of the one or more transparent primitives:
determining whether a depth of each transparent primitive of the at least one transparent primitive is less than the depth of the visible primitive relative to the image plane at the pixel;
in an event that the depth of one transparent primitive of the at least one transparent primitive is less than the depth of the visible primitive relative to the image plane at the pixel, providing at least an identification of the one transparent primitive for rendering of the one transparent primitive at the pixel; and
in an event that the depths of multiple transparent primitives of the at least one transparent primitive are less than the depth of the visible primitive relative to the image plane at the pixel, providing at least identifications of the multiple transparent primitives in a descending order with respect to the depths of the multiple transparent primitives such that the pixel is rendered first with data associated with a first transparent primitive of the multiple transparent primitives and then with data associated with a second transparent primitive of the multiple transparent primitives, wherein a depth of the first transparent primitive is greater than a depth of the second transparent primitive but not greater than the depth of the visible primitive relative to the image plane at the pixel.

20. A graphics processing unit (GPU), comprising:
a first buffer;
a second buffer;
a control circuit coupled to the first buffer and the second buffer, the control circuit configured to perform operations comprising:
storing identifications of a set of visible primitives among one or more primitives of a plurality of primitives associated with the bin in the first buffer; and
storing values of the depths of the set of visible primitives corresponding to the plurality of pixels of the bin in the second buffer; and
a rendering unit coupled to the control circuit, the rendering unit configured to performing operations comprising:
receiving the identifications of the visible primitives from the first buffer in batches; and
rendering the plurality of pixels of the bin in batches based at least in part on data related to the visible primitives such that a batch of multiple pixels of the plurality of pixels of the bin are rendered at a time.
